(19) United States
(12) Patent Application Publication
(10) Pub. No.: US 2026/0095839 A1
(43) Pub. Date: Apr. 2, 2026

(54) RADIO AND SYSTEM

(71) Applicant: Visban, Co., Ltd., Tokyo (JP)

(72) Inventors: Tajinder Manku, Waterloo (CA); Arokia Nathan, Hertfordshire (GB); Suk-Bae Cha, Tokyo (JP)

(21) Appl. No.: 19/110,404

(22) PCT Filed: Sep. 12, 2023
(86) PCT No.: PCT/GB2023/052358

§ 371 Date: Mar. 10, 2025

(30) Foreign Application Priority Data
Sep. 12, 2022 (GB) 2213284.9

(51) Int. Cl. H04W 40/12; H04W 40/22

(52) U.S. Cl. CPC H04W 40/12; H04W 40/22

(57) ABSTRACT

A radio includes: a first transceiver and a second transceiver for a first frequency band, the radio to relay a radio signal received by the second transceiver to the first transceiver via an analog signal path and to retransmit the radio signal using the first transceiver; and a control transceiver for communicating with a wireless network including other radios using a second frequency band. Each of the other radios includes same elements as the radio. The radio is to coordinate with the other radios via the wireless network to: control the first transceiver and the second transceiver to determine a network map for relaying radio signals within the first frequency band; and determine one or more time-multiplexed routing configurations of the radio. The radio is, during a time period corresponding to time-multiplexed routing configuration, to steer the first transceiver to first configuration direction corresponding to one of the other radios.

### RELATED APPLICATIONS

This application claims the benefit under 35 U.S.C. § 371 of International Patent Application No. PCT/GB2023/052358, filed Sep. 12, 2023, which claims priority to United Kingdom Application No. GB 2213284.9, filed Sep. 12, 2022, the contents of each are incorporated by reference in their entirety.

### TECHNICAL FIELD

The present disclosure relates to wireless transceivers and methods for operating wireless transceivers, and further relates to wireless transceivers for wireless communications networks which rely on line-of-sight or near line-of-sight communications, for example utilizing radio signals with frequencies exceeding 5 GHz.

### BACKGROUND

As wireless communications networks move towards higher frequencies to improve data rates, the corresponding decrease in wavelengths can lead to issues with providing uniform coverage in areas without line of sight to a transmitter, for example, in urban areas, forested areas, inside structures and so forth.

As wireless communications networks start to move to frequencies at and above 5 GHz (sometimes termed “fifth generation” or “5G”), the effects of attenuation by atmospheric gasses such as oxygen (O₂), carbon dioxide (CO₂) and water vapor (H₂O) can be significant in some frequency bands. Atmospheric weather effects can exacerbate such issues, for example attenuation may reach in the region of 60 dB·m⁻¹.

Providing wireless network coverage to the interior of structures such as building and sports stadiums is already an issue for frequencies below 5 GHz. Moving to higher frequencies will cause further degradation of signal intensities penetrating into structures. Improvements in building glass relating to thermal regulation, for example inclusion of thin mentalized layers to help keep buildings cooler, may further attenuate radio signals from the exterior.

CN 106992807 A describes a signal relay system for 5G communication. US 2018/139521 A1 describes a transparent wireless bridge for providing access to an optical fiber network. US 2015/380816 A1 describes an antenna control system and a method capable of consistently maintaining an optimum orientation point between a donor antenna and an adjacent base station. US 2004/110469 A1 describes a flat-panel repeater. US 2020 091990 A1 describes multi-band antenna arrangements.

### SUMMARY

According to a first aspect of the present disclosure, there is provided a radio for networked relaying of radio signals within a first frequency band. The radio includes a first transceiver for the first frequency band. The first transceiver is electronically steerable to a first direction. The radio also includes a second transceiver for the first frequency band. The radio is configured to relay a radio signal received by the second transceiver to the first transceiver via an analog signal path and to retransmit the radio signal using the first transceiver. The radio also includes a control transceiver for communicating with a wireless network using a second frequency band lower than the first frequency band. The wireless network includes a plurality of other radios. Each of the other radios includes the same elements as the radio. The radio is configured to coordinate with the plurality of other radios via the wireless network, in order to control the first and second transceivers to determine a network map for relaying radio signals within the first frequency band, and to determine one or more time-multiplexed routing configurations of the radio. The radio is configured, during a time period corresponding to at least one time-multiplexed routing configuration, to steer the first transceiver to a respective first configuration direction corresponding to one of the other radios.

Two or more time-multiplexed routing configurations may be identical for a given radio. All time-multiplexed routing configurations may be identical for a given radio.

The radio may be configured, during a time period corresponding to every time-multiplexed routing configuration, to steer the first transceiver to a respective first configuration direction corresponding to one of the other radios. The radio may be configured, during a time period corresponding to every time-multiplexed routing configuration, to steer the first transceiver to a respective first configuration direction corresponding to the same one of the other radios.

The first and second wireless transceivers may be configured for a radio signal in accordance with the definition of 5G used in “5G Evolution: A View on 5G Cellular Technology Beyond 3GPP Release 15”, Amitabha Ghosh, Andreas Maeder, Matthew Baker and Devaki Chandramouli, IEEE Access (2019), Vol. 7, pg 127639, DOI 10.1109/ACCESS.2019.2939938.

The first and second transceivers may be configured for radio signals having carrier frequencies between and including 5 GHz and 300 GHz. The first and second transceivers may be configured for radio signals having carrier frequencies between and including 30 GHz and 300 GHz. The first and second transceivers may be configured for radio signals having carrier frequencies within one or more of the K (20 GHz to 40 GHZ), L (40 GHz to 60 GHz) and M (60 GHz to 100 GHz) bands defined by NATO. The first and second transceivers may be configured for radio signals having carrier frequencies within one or more of the Ka (27 GHz to 40 GHz), V (40 GHz to 75 GHZ) and W (75 GHz to 110 GHz) bands defined by the Institute of Electrical and Electronics Engineers (IEEE). The first and second transceivers may be configured for radio signals having carrier frequencies exceeding 300 GHz. The first and second transceivers may be configured for radio signals having carrier frequencies equaling or exceeding 1 THz. The first and second transceivers may be configured for a radio signal which is a 5G signal. The first and second transceivers may be configured for a radio signal which is a 6G signal. The first and second transceivers may be configured for a radio signal which is a 7G signal.

The second frequency band may have a central frequency which is less than a central frequency of the first frequency band. The second frequency band may have a central frequency which is ten (or more) times less than a central frequency of the first frequency band.

The second frequency band may have an upper bound which is less than or equal to a lower bound of the first frequency band. In other words, the second frequency band may be less than and non-overlapping with the first frequency band. The wireless network may comply with, for example IEEE 802.11ax-2021 standard published on 19 May 2021, or any earlier or later published IEEE standard. The wireless network may correspond to a 3G mobile communication network. The wireless network may correspond to a 4G mobile communication network.

The first direction may be bounded by a first angular range. In other words, the first direction may be steerable to orient a main lobe of a corresponding radiation pattern within the first angular range.

Each first configuration direction may be directed towards a target radio of the plurality of other radios corresponding to the respective time-multiplexed routing configuration.

The analog signal path does not include down-conversion between the first and second transceivers.

The radio may be configured to transmit steering data to one or more of the other radios. Steering data may include one or more of a location of the radio, for example a GPS location, a velocity of the radio, an acceleration of the radio and a bearing of the radio. The radio may be configured to transmit steering data via the wireless network. The radio may be configured to receive steering data corresponding to at least one of the one or more of the other radios. Steering data corresponding to at least one of the one or more of the other radios may include one or more of a location of the at least one other radio, for example a GPS location, a velocity of the at least one other radio, an acceleration of the at least one other radio and a bearing of the at least one other radio. The radio may be configured to receive steering data via the wireless network.

Coordinating with the plurality of other radios via the wireless network to determine the network map may include controlling the first transceiver to transmit a test signal whilst scanning the first direction through a range of available angles. Coordinating with the plurality of other radios via the wireless network to determine the network map may include listening, via the wireless network, for one or more LOS confirmation messages transmitted by other radios. Each LOS confirmation message may include a reception time and an identifier of a corresponding other radio. Coordinating with the plurality of other radios via the wireless network to determine the network map may include, in response to receiving a LOS confirmation message from one of the other radios, determining the first direction corresponding to the respective reception time and adding that other radio to a routing table stored by the radio.

The routing table may include a list of other radios and corresponding first directions. The network map may be formed by aggregating the routing tables of the radio and all the other radios communicatively coupled to the wireless network.

Each confirmation message may also include a quality metric. The routing table may also include and/or store the quality metric corresponding to each respective connection.

The test signal may encode a unique identifier of the radio. The unique identifier may be encoded by modulating the frequency and/or amplitude of the test signal. The unique identifier may be encoded by a carrier frequency of the test signal.

Coordinating with the plurality of other radios via the wireless network to determine the network map may include listening, using the second transceiver, for one or more test signals transmitted by other radios. Coordinating with the plurality of other radios via the wireless network to determine the network map may include, in response to receiving a test signal from one of the other radios, to transmit a LOS confirmation message to that other radio via the wireless network. The LOS confirmation message may include an identifier of the radio and a reception time corresponding to a maximum power of the test signal.

The source of the test signal for routing of the confirmation message may be determined based on a unique identifier of the other radio encoded in the test signal. The source of the test signal for routing of the confirmation message may be determined based on a schedule defining times at which the radio and each of the other radios transmits test signals.

Receiving a test signal from one of the other radios may take the form of receiving a test signal which exceeds a threshold signal level. The threshold signal level may be a threshold power, or a threshold amplitude. The threshold signal level may be set to a multiple of a standard error of noise on the second receiver output. The threshold signal level may be set to the standard error, twice the standard error, three times the standard error or five times the standard error. The standard error may be pre-calibrated, calibrated upon installation, and/or periodically updated during use.

The determination of one or more time-multiplexed routing configurations of the radio may be based on a dynamic routing method. The dynamic routing method may be based on a distance-vector routing protocol. The dynamic routing method may be based on a link-state routing protocol. The dynamic routing method may be based on any known routing protocol, applied to a network map determined based on the first group and second group of the radio and of each other radio comprised in the wireless network.

The radio may be configured to coordinate with the plurality of other radios via the wireless network to control the first and second transceivers to determine a network map according to a schedule.

The radio may be configured to coordinate with the plurality of other radios via the wireless network to control the first and second transceivers to determine a network map in response to receiving a mapping request message. The mapping request message may be generated in response to a new other radio joining the wireless network. The mapping request message may be generated in response to one of the other radios leaving the wireless network. The mapping request message may be generated in response to the radio, or one of the other radios, has changed one or more of location, velocity, rate of acceleration and so forth.

The radio may be configured, in response to relaying a radio signal using the first and second transceivers to transmit, via the wireless network, a first relay confirmation message to a source radio of the plurality of other radios corresponding to an active time-multiplexed routing configuration. The radio may be configured, in response to relaying a radio signal using the first and second transceivers to listen for a predetermined period, via the wireless network, for a second relay confirmation message from a target radio of the plurality of other radios corresponding to the active time-multiplexed routing configuration. The radio may be configured, in response to relaying a radio signal using the first and second transceivers in response to the predetermined period elapsing without reception of the second relay confirmation message, to increment a failure counter corresponding to the target radio. The radio may be configured, in response to relaying a radio signal using the first and second transceivers, in response to the failure counter exceeds a broken-link threshold, to transmit a mapping request message via the wireless network.

The active time-multiplexed routing configuration may be the time-multiplexed routing configuration which is being used at the time of relaying the radio signal.

The failure counter corresponding to a particular target radio may be reset to an initial value (for example zero) in response to a reset period elapsing without that failure counter being incremented. The reset period may be at least one or more times a total cycling period of the one or more time-multiplexed routing configurations. In other words, the failure counter corresponding to a particular target radio may not be reset until all the routing configurations of the radio have been cycled at least once without a failure. Preferably, the failure counter corresponding to a particular target radio may not be reset until all the routing configurations of the radio have been cycled several times without a failure, for example, ten times or more.

The second transceiver may be electronically steerable to a second direction. The second direction may be bounded by a second angular range. In other words, the second direction may be steerable to orient a main lobe of a corresponding radiation pattern within the second angular range.

The first and second angular ranges may overlap. The first and second angular ranges may not substantially overlap. The first and second angular ranges have central angles (corresponding to a mean average angle for each respective angular range) pointing in different directions. The first and second angular ranges may be identical except for having central angles pointing in different directions.

Listening, using the second transceiver, for one or more test signals transmitted by other radios, may include scanning the second direction through a range of available angles. Whilst listening, using the second transceiver, for one or more test signals transmitted by other radios, the radio may be configured to scan the second direction through a range of available angles, i.e., the second angular range.

The second transceiver may be configured to be operable in a first mode and a second mode. The first mode may correspond to a radiation pattern including a beam which is electronically steerable to the second direction. The second mode may correspond to reception of signals from a broader angular distribution than the beam of the first mode. Whilst listening, using the second transceiver, for one or more test signals transmitted by other radios, the radio may be configured to operate the second transceiver in the second mode. Each time-multiplexed routing configuration may define whether the second transceiver is operated in the first mode or the second mode.

The first and second modes may correspond to switching between different antennae or arrays of antennae.

The first and second modes may correspond to the same antennae or arrays of antennae. In the first mode, the antennae of an array may be controlled as a phased array. In the second mode, some or all of the antennae of the array may be switched to connect to respective summing amplifiers. Each summing amplifier may have a relatively higher gain than any amplifier used for a single from an antenna of the array during the first mode.

The radio may be configured, during a time period corresponding to at least one time-multiplexed routing configuration, to steer the second transceiver to a respective second configuration direction corresponding to one of the other radios. The radio may be configured, during a time period corresponding to every time-multiplexed routing configuration, to steer the second transceiver to a respective second configuration direction corresponding to one of the other radios. The radio may be configured, during a time period corresponding to every time-multiplexed routing configuration, to steer the second transceiver to a respective second configuration direction corresponding to the same one of the other radios.

In this way, the time-multiplexed routing configuration may correspond to steering the first transceiver to a first configuration direction corresponding to a target radio, whilst also steering the second transceiver to a second configuration direction corresponding to a source radio. The first and second configuration directions corresponding to source and target radios may be retrieved from the routing table.

The radio may also include a third transceiver for the first frequency band. The third transceiver may be electronically steerable to a third direction. The radio may also include a fourth transceiver configured the same as the second transceiver. The radio may be configured to relay a radio signal received by the fourth transceiver to the third transceiver via a second analog signal path, and to retransmit the radio signal using the third transceiver. The radio may be configured, during a time period corresponding to at least one time-multiplexed routing configuration, to steer the third transceiver to a respective third configuration direction corresponding to one of the other radios, so as to relay radio signals in the opposite direction to the first and second transceivers.

In other words, the source radio for the fourth transceiver may be the target radio of the first transceiver, and the target radio for the third transceiver may be the source radio of the second transceiver.

The third transceiver may include features corresponding to any features of the first transceiver. The fourth transceiver may include features corresponding to any features of the second transceiver.

The radio may be configured to relay a radio signal received by the second transceiver to the first transceiver via an analog signal path and to retransmit the radio signal using the first transceiver during time periods corresponding one or more first time-multiplexed routing configurations. The radio may be configured to relay a radio signal received by the first transceiver to the second transceiver via an analog signal path and to retransmit the radio signal using the second transceiver during time periods corresponding one or more second time multiplexed routing configurations. In other words, the relaying between first and second transceivers may be configured for duplex communication.

The radio may also include a receiver channel coupled to the analog signal path and configured to detect test signals. The receiver channel may include one or more of a frequency analyzer, a pulse analyzer, and so forth. The receiver channel and the radio may be incapable of extracting and processing data packets relayed via the analog signal channel. In other words, the receiver channel need only be configured for coarse resolution in time and frequency, and is not intended to be used to extract or process data packets being relayed in the first frequency band. The receiver channel may be coupled to the analog signal path using one or more switches. The radio may be configured to disconnect the receiver channel from the analog signal path when not in use.

The radio may also include a second receiver channel coupled to the second analog signal path and configured to detect test signals. The second receiver channel may be configured in any way described in relation to the receiver channel.

The radio may also include a test transmission channel coupled to the analog signal path and configured to inject a test signal for transmission by the first transceiver. The test transmission channel may be coupled to the analog signal path using one or more switches. The radio may be configured to disconnect the test transmission channel from the analog signal path when not in use.

The radio may also include a second test transmission channel coupled to the second analog signal path and configured to inject a test signal for transmission by the third transceiver. The second test transmission channel may be configured in any way described in relation to the test transmission channel.

A system may include a number of the radios. The wireless network may be formed between all the radios. Each radio may be configured to coordinate with all the other radios via the wireless network to control the first and second transceivers to determine a network map of the system for relaying radio signals within the first frequency band. Each radio may be configured to coordinate with all the other radios via the wireless network to determine one or more time-multiplexed routing configurations for each of the radios.

The configuration of each radio to coordinate with the plurality of other radios of the system via the wireless network to determine the network map may, for each radio, controlling the first transceiver of that radio to transmit a test signal whilst scanning the first direction through a range of available angles, listening, via the wireless network, for one or more LOS confirmation messages transmitted by the other radios, each LOS confirmation message comprising a reception time and an identifier of a corresponding other radio; and in response to receiving a LOS confirmation message from one of the other radios, determining the first direction corresponding to the respective reception time and adding that other radio to a routing table stored by that radio and/or stored elsewhere within the system.

The routing table may include a list of other radios and corresponding first directions. The network map may be formed by aggregating the routing tables of the radio and all the other radios communicatively coupled to the wireless network. Each radio may store a local routing table. The system may additionally store copies of each local routing table at a centralized location, for example, one of the radios or an additional device communicatively coupled to the wireless network. Each radio may broadcast copies and/or updated to its local routing table, and each radio may store local copies of the routing table corresponding to some or all of the other radios in the system.

Each confirmation message may also include a quality metric. The routing table may also include the quality metric corresponding to each respective connection.

The test signal may encode a unique identifier of the radio. The unique identifier may be encoded by modulating the frequency and/or amplitude of the test signal. The unique identifier may be encoded by a carrier frequency of the test signal.

The configuration of each radio to coordinate with the plurality of other radios of the system via the wireless network to determine the network map may include, for each radio, listening, using the second transceiver of that radio, for one or more test signals transmitted by other radios; and in response to receiving a test signal from one of the other radios, to transmit a LOS confirmation message to that other radio via the wireless network. The LOS confirmation message may include an identifier of that radio and a reception time corresponding to a maximum power of the test signal.

The source of the test signal for routing of the confirmation message may be determined based on a unique identifier of the other radio encoded in the test signal. The source of the test signal for routing of the confirmation message may be determined based on a schedule defining at which times the radio and each of the other radios will transmit test signals.

Receiving a test signal from one of the other radios may take the form of receiving a test signal which exceeds a threshold signal level. The threshold signal level may be a threshold power, or a threshold amplitude. The threshold signal level may be set to a multiple of a standard error of noise on the second receiver output. The threshold signal level may be set to the standard error, twice the standard error, three times the standard error or five times the standard error. The standard error may be pre-calibrated, calibrated upon installation, and/or periodically updated during use.

Processing to determine the network map and the one or more time-multiplexed routing configurations for each of the radios may be carried out by a subset of one or more of the plurality of radios forming the system.

Processing to determine the network map and the one or more time-multiplexed routing configurations for each of the radios may be distributed across two of more of the plurality of radios forming the system.

The determination of one or more time-multiplexed routing configurations for each radio in the system may be based on a dynamic routing method. The dynamic routing method may be based on a distance-vector routing protocol. The dynamic routing method may be based on a link-state routing protocol. The dynamic routing method may be based on any known routing protocol, applied to a network map determined based on the first group and second group of the radio and of each other radio comprised in the wireless network.

The system may also include a gateway and one or more user devices. The one or more time-multiplexed routing configurations for each of the radios may be determined such that each user device of the plurality of user devices has a connection to the gateway via the plurality of radios during at least one time period. The system may include two or more gateways. The one or more time-multiplexed routing configurations for each of the radios may be determined such that each user device has a connection to at least one gateway during at least one time period.

Each user device may include a wireless transceiver for the first frequency band. Additionally, the user device may include a wireless transceiver for the second frequency band. Any or all user devices connected to the system may connect to the wireless network and may be coordinated with the radios to perform network mapping and/or routing configurations in an analogous manner to the radios. In other words, with the exception of not requiring a second wireless transceiver and an analog signal path, and being a start/end point for radio signals, user devices may include any features of the radios. In other examples, user devices may additionally function as radios for relaying radio signals.

A user device may be any of a mobile phone, a smartphone, a tablet computer, a smart watch, a laptop computer, and so forth. One, some or all of the user devices may be configured to transmit and/or received steering data to the one or more radios of the plurality of radios, via the wireless network. Steering data may be as defined hereinbefore.

The plurality of radios forming the system may include one or more radios supported by a structure, one or more radios supported by a vehicle, and/or one or more user devices. Each radio of one or more radios supported by the structure may be supported on an exterior of the structure or supported internally within the structure.

One or more user devices may also be radios defined according to the first aspect. Two or more radios of the plurality of radios forming the system may be supported by the structure. The structure may be a building. Each radio may be supported by a window, wall (internal or external), door or roof of a building. Each radio may be supported by a different window. Two or more radios may be supported by the same window wall (internal or external), door or roof of a building. The structure may be a bus shelter, a lamp post, or any other item of street furniture. Supported by a structure may include attachment to the structure, mounting to the structure, and so forth. Supported by a structure may additionally or alternatively include radios being incorporated into, or integrally formed with, the structure. Two or more radios of the plurality of radios may be supported by two or more separate structures (structures having the same meaning as already explained). All of the radios of the plurality of radios may be supported on respective structures.

The system may include a number of radios supported internally within one or more structures. In this way, the relaying radio signals in the first frequency band may be conducted seamlessly outside, around, and also inside structures. In some examples, a majority, or even all, of the radios may be supported within a structure or similar (for example an underground rail/metro network), to provide relaying of radio signals in the first frequency band.

The vehicle may be a car, a bus, a van, a truck, a lorry and so forth. The system may include one or more radios supported a window or a portion of the bodywork of the vehicle.

Each radio of the plurality of radios forming the system may be located within 200 m, within 100 m, within 50 m, within 20 m or within 10 m of at least one other radio of the plurality of radios.

The system may also include one or more control nodes. Each control node may be communicatively coupled to two or more of the radios. Each control node may be configured to coordinate network mapping and/or routing by the corresponding radio transceivers. Each control node may be communicatively coupled to the corresponding radio via a wired network and/or the wireless network. Each control node may be communicatively coupled to the corresponding radio transceivers via a wireless network. Each control node may correspond to a radio of the plurality of radios. Every radio of the plurality of radios may include processing capacity, and the control and coordination of network mapping and/or routing may be executed in parallel across the radio transceivers.

According to a method for networked relaying of radio signals within a first frequency band using a radio according to the first aspect or a system including a plurality of radios according to the first aspect. The method includes coordinating the radio with a plurality of other radios to determine a network map for relaying radio signals within the first frequency band. The method also includes determining one or more time-multiplexed routing configurations of the radio. The method also includes, during each of one of more time periods corresponding to time-multiplexed routing configurations, steering the first transceiver of the radio to a respective first configuration direction corresponding to one of the other radios; and in response to receiving a radio signal in the first frequency band using the second transceiver, relaying that radio signal via the analog signal path and retransmitting that radio signal using the first transceiver.

The method may include features corresponding to any features of the radio of the first aspect or the system incorporating a plurality of radios according to the first aspect. Definitions applicable to the radio of the first aspect and/or the system incorporating a plurality of radios according to the first aspect may be equally applicable to the method.

### BRIEF DESCRIPTION OF THE DRAWINGS

Certain embodiments of the present disclosure will now be described, by way of example, with reference to the accompanying drawings in which:

FIG. 1 schematically illustrates a system including a number of radios for relaying radio signals;

FIG. 2 schematically illustrates a radio suitable for use in the system of FIG. 1;

FIG. 3 schematically illustrates a time-multiplexed access scheme for a radio 2;

FIG. 4 schematically illustrates another example of a system including a number of radios for relaying radio signals;

FIGS. 5A and 5B schematically illustrate a first directional configuration for a radio;

FIG. 6 schematically illustrates a second directional configuration for a radio;

FIG. 7 schematically illustrates a first configuration for switching between modes of a radio corresponding to different directional configurations;

FIG. 8 schematically illustrates a second configuration for switching between modes of a radio corresponding to different directional configurations;

FIG. 9 schematically illustrates an example of a layout for a phased array of planar antennae;

FIG. 10 schematically illustrates a pair of radios separated by a line-of-sight blocking object;

FIG. 11 is a process flow diagram of a method of mapping line-of-sight links between radios;

FIG. 12 is a process flow diagram of a method of monitoring the state of line-of-sight links;

FIG. 13 schematically illustrates a first exemplary system including a pair of structures;

FIG. 14 schematically illustrates a second exemplary system corresponding to a portion of an urban area; and

FIG. 15 schematically illustrates a third exemplary system for relaying of radio signals between, and within, a pair of buildings.

### DETAILED DESCRIPTION

In the following description, like parts are denoted by like reference numerals.

The problems of line-of-sight to a base station and atmospheric and/or weather attenuation of radio signals may be mitigated by adding further wireless transceivers to a wireless network. The direction of the Poynting vector of radio signals, especially for non-line-of-sight environments, is important to maximizing quality of service performance. For these reasons directional, line-of-sight communications are increasingly important for high data-rate wireless communications networks.

The current infrastructure for wireless communications is expected to encounter limitations and underlying issues which will make it difficult to scale towards higher frequencies, for example towards (or beyond) mm-waves. As the demand for higher bandwidth is driven ever upwards for new services such as mobile data, content streaming and so forth, the size of an area (or “cell”) covered by a single transmitter tower had become increasingly small. This trend is expected to continue for frequencies above 5 GHZ, often referred to as “5G”. The current infrastructure of cell towers is approaching its limits, and a new approach is required as wireless communications networks increasing move towards a line-of-sight, point-to-multipoint system operating at high frequencies and high data rates. Such high frequency communications, for example mm-wave, may also benefit considerably from the use of massively multi-input-multiple-output antenna architectures to allow beam-forming and beam-steering. Highly directional operation may help to avoid issues with multi-path interference.

Driven by consumer demands for increasingly diverse and immersive mobile data services, for example high-definition video streaming, cloud-based services, augmented reality and so forth, next generation wireless communication networks and systems will need to offer high throughput, low latency and reliability to remain competitive. For example, beyond the currently planned infrastructure to move up to 6 GHZ, there is an additional 200 GHz of spectrum available at mm-wave frequencies that is under-utilized, and which could potentially support data rates in the region of 10 to 50 Gb per second.

Wide spectrum does not mean it is unlimited, and other services will also utilize the same, or neighboring, bands. If significant portion of spectrum is exclusively granted to a single independent mobile network operator, there will be inefficiency of spectrum utilization. An average consumer may utilize cm-waves with spectrum ranging from 3 to 30 GHz, and between 30 and 40 GHz (up to 300 GHZ) as a mm-wave spectrum.

There is also spectrum sharing at 60 to 70 GHz for mission-critical services, which includes smart city infrastructure, healthcare, self-driving cars, and many other applications. Such services should preferably have access to a continuous high-speed, low-latency connection, and shared spectrum has the potential to help ensure that devices are always connected.

Whilst line-of-sight issues arising in such high-frequency wireless communications networks may start to be addressed by adding further wireless transceivers to a network, in practice the immediately arising question is how such networks may be mapped, and network routing coordinated, given that many wireless transceivers in such a network will not possess line-of-sight to one another?

This specification concerns wireless transceivers in the form of radios, and systems thereof, which address the issue of how to allow wireless networks operating at high frequencies necessitating line-of-sight to be coordinated to allow relaying around obstructions. In some embodiments, certain examples concern performing such coordination dynamically, which may be especially important when radios may join and leave a network, and/or may change positions relative to one another during use.

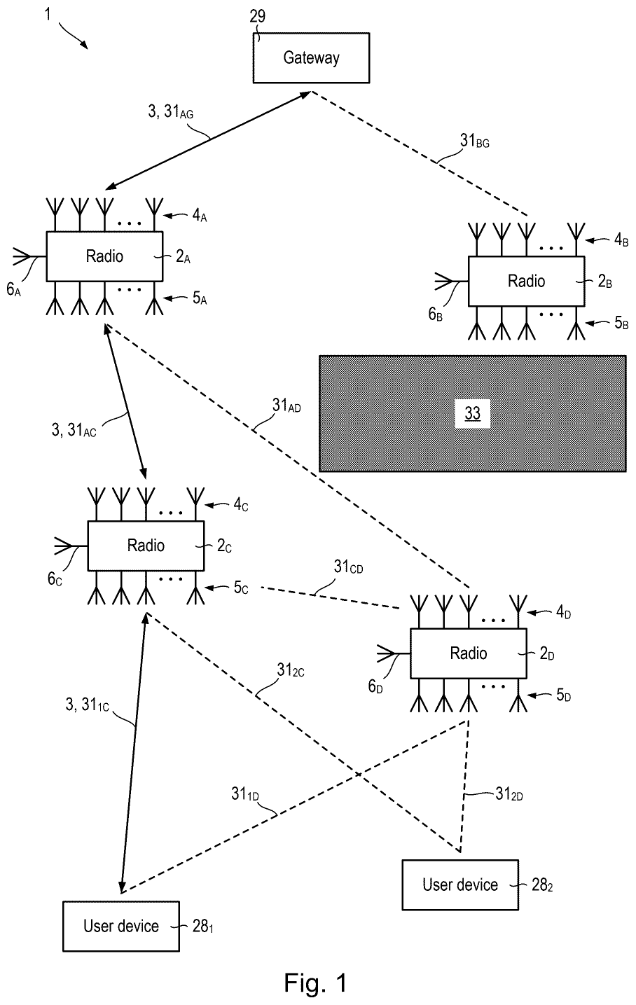

Referring to FIG. 1, a system 1 including a number of radios 2_{A}, . . . , 2_{D} is shown. The subscripts refer to separate instances, and a radio 2 in general will be referred to without subscript. The same convention applies to labelling components of each radio 2.

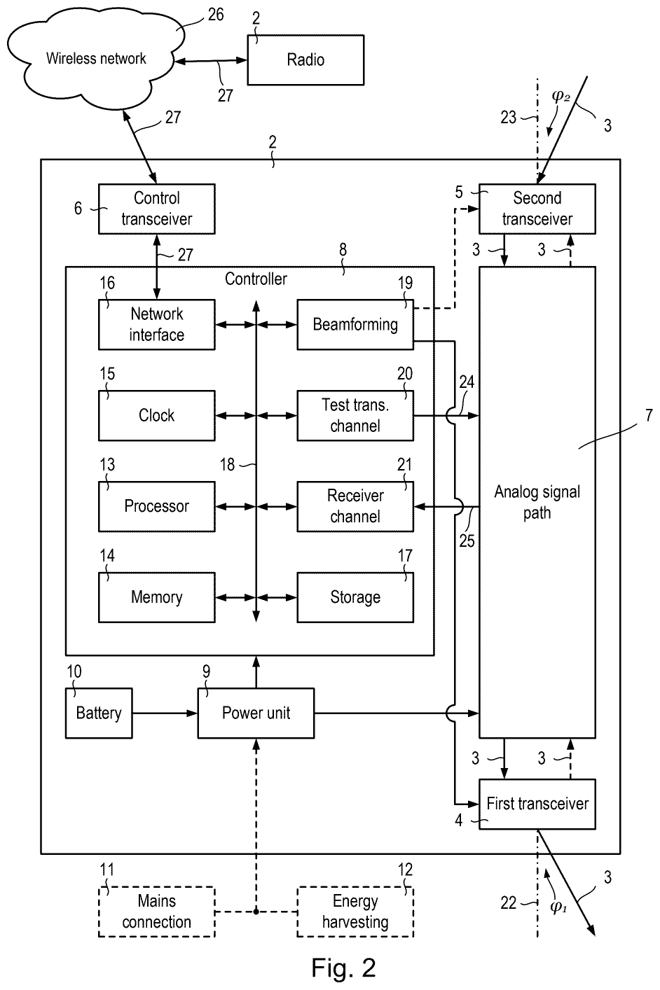

Each radio 2 (and the overall system 1) is configured for relaying of radio signals 3 within a first (or signal) frequency band Δf_{sig} extending from a lower signal frequency f₁ to an upper signal frequency f₂. For this purpose, each radio 2 includes first 4 and second 5 transceivers configured for sending and/or receiving radio signals 3 in the first frequency band Δf_{sig}. Each first transceiver 4 is electronically steerable to a first direction φ₁ (FIG. 2). For example, each first transceiver 4 may include, or take the form of, a phased antenna array. Each second transceiver 5 may be omnidirectional, wide angle (for example a majority of a hemisphere), or may be electronically steerable to a second direction φ₂ (FIG. 2). When electronically steerable, the second transceiver may include, or take the form of, a phased antenna array.

Each radio 2 also includes a control transceiver 6 for communicating with a wireless network 26 (FIG. 2) which includes that radio 2 and the other radios 2 belonging to the system 1. The control transceiver 6 is configured for communications using a second (or control) frequency band Δf_{cont} extending from a lower control frequency f₃ to an upper control frequency f₄. The second frequency band Δf_{cont} is lower than the first frequency band Δf_{sig} (and the frequency bands preferably do not overlap). For example, f₄<f₁, and in many cases f₄<<f₁.

Each radio 2 is configured to relay radio signals 3 received by the second transceiver 5 to the first transceiver 4 via an internal, analog (equivalently analogue), signal path 7 (FIG. 2), and to retransmit the radio signal 3 using the first transceiver 4.

The system 1 may include radios 2 spread through any area/region in which LOS for radio signals 3 is liable to interruption. For example, the system 1 may be installed in urban areas, including radios 2 for relaying radio signals 3 externally around buildings, and extending inside buildings to permit relaying radio signals 3 within buildings and/or underground. For example, a system 1 may include radios 2 above ground in communication with radios 2 in underground structures such as car parks, underground rail/metro systems and so forth. In this way, the system 1 may allow seamless relaying of radio signals 3 between exterior and interior environments.

The system 1 may include radios 2 owned or controlled by different persons or companies. For example, a telephone company may control radios 2 which are distributed around the exterior of an urban area, whilst building owners/managers may control radios 2 installed within a particular building. All such sub-networks are capable to interoperation for relaying radio signals 3 across boundaries between adjacent/interpenetrating sub-networks. However, in some examples the controller of a sub-network may optionally choose to restrict or block relaying radio signals 2 within particular frequency ranges of the first frequency band Δf_{sig}.

Referring also to FIG. 2, one example of a suitable radio 2 is shown.

Although FIG. 2 shows a specific example of a radio 2, it is not essential that all radios 2 in the system 1 be identical, provided that each is capable of providing the functionality described herein. For example, radios 2 according to the present specification should include at least the first and second transceivers 4, 5, the control transceiver 6 and the analog signal path 7.

In the example of FIG. 2, the radio 2 includes the first 4 and second 5 transceivers connected by the analog signal path 7, the control transceiver 6, a controller 8, a power unit 9 and a battery 10. Optionally, the power unit 8 may be further coupled to a mains connection 11 external to the radio 2 and/or to one or more energy harvesting devices 12. For example, the battery 10 may be re-charged using power from energy harvesting device(s) 12. In another example, the radio 2 may be configured to run from mains power during normal operation, with the battery 10 serving as a backup in case of power failure. The power unit 9 distributes and regulates power supplied to the controller 8 and the analog signal path 7. As further described hereinafter, the analog signal 7 path includes elements such as amplifiers for reception and transmission of radio signals 3, and is generally expected to draw more power than the controller 8.

The controller 8 includes a digital electronic processor 13, volatile memory 14 such as random-access memory (RAM) for use in computations, a clock 15 (which may be integral with the processor 13 in some examples), a network interface 16 and non-volatile storage 17 such as read-only memory (ROM), a hard disc drive and so forth. The components of the controller 8 (and potentially other components of the radio 2) are interconnected by a bus 18. The controller 8 also includes a beamforming module 19, a test transmission channel 20 and a receiver channel 21.

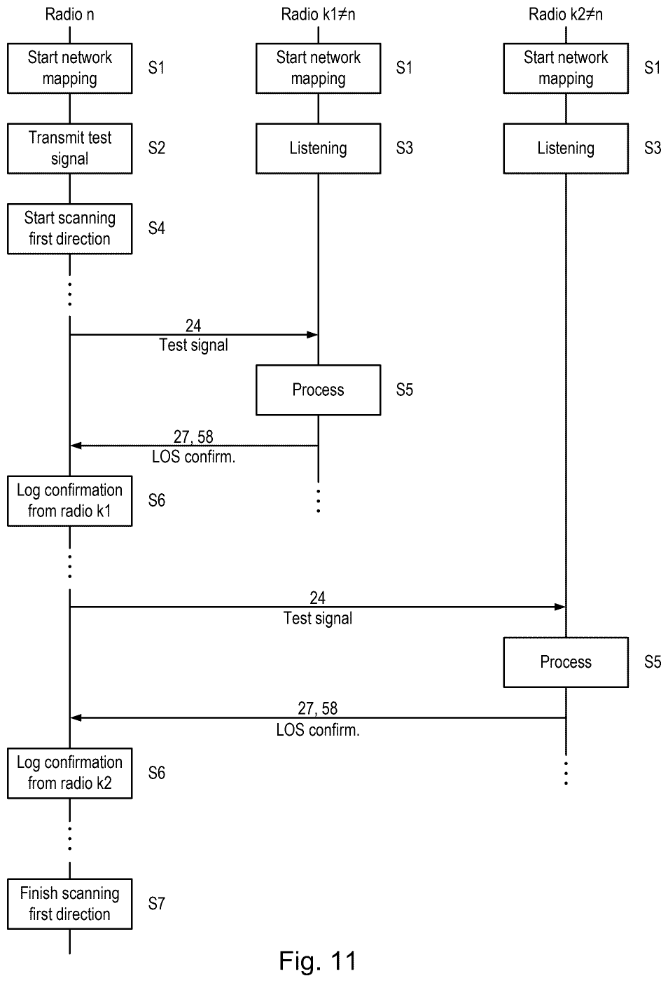

The beamforming module 19 controls the electronic steering of the first transceiver 4 to the first angle φ₁ (relative to a first reference direction 22). When the second transceiver 5 is also electronically steerable, the beamforming module 19 additionally controls the electronic steering of the second transceiver 5 to the second angle φ₂ (relative to a second reference direction 23). The test transmission channel 20 is configured to generate a test signal 24, and inject it into the analog signal path 7 for transmission by the first transceiver 4 during a network mapping procedure described hereinafter (see FIG. 11). The receiver channel 21 obtains a sampling 25 of signals received by the second transceiver 5 to facilitate detection of test signal 24 transmitted by a different radio 2 during the network mapping procedure described hereinafter (see FIG. 11).

Each (or any combination) of the beamforming module 19, the test transmission channel 20 and the receiver channel 21 may be provided by software blocks held in the storage 17 and executed by the processor 13, or may alternatively be implemented using specifically configured hardware circuits. In some examples, Each (or any combination) of the beamforming module 19, the test transmission module 20 and the receiver channel module 21 may be provided by a combination of specifically configured hardware circuit(s) and software executed by the processor 13.

The wireless network 26 is formed between all the radios 2 in the system 1. Each radio 2 is configured to coordinate with all the other radios 2 via the wireless network 26, for example by exchanging one or more control and coordination messages 27 via the respective control transceivers 6.

The first 4 and second 5 wireless transceivers are configured for radio signals having carrier frequencies between f₁=5 GHz and f₂=300 GHz. Preferably, the first 4 and second 5 wireless transceivers may be configured for a radio signal in accordance with the definition of 5G used in “5G Evolution: A View on 5G Cellular Technology Beyond 3GPP Release 15”, Amitabha Ghosh, Andreas Maeder, Matthew Baker and Devaki Chandramouli, IEEE Access (2019), Vol. 7, pg 127639, DOI 10.1109/ACCESS.2019.2939938. Another preferred range is between f₁=30 GHz and/2=300 GHz. These ranges represent frequency ranges expected to be increasingly relevant in the coming year, but in principle the operating frequencies of the first 4 and second 5 wireless transceivers are limited only by the state of the art in antenna design and associated electronics. For example, the first 4 and second 5 wireless transceivers may be configured for radio signals having carrier frequencies exceeding 300 GHz, or even exceeding 1 THz. As explained herein, the direct analog signal path 7 provided between the first 4 and second 5 transceivers enables signal relaying at high frequencies without any need for the radio 2 to down-convert, convert to the digital domain, or even understand routing contents of, a relayed radio signal 3. This enables keeping the complexity, costs and power consumption of the radio 2 as low as possible, which is important given the numbers necessary to provide a line-of-sight network in some environments (for example urban environments).

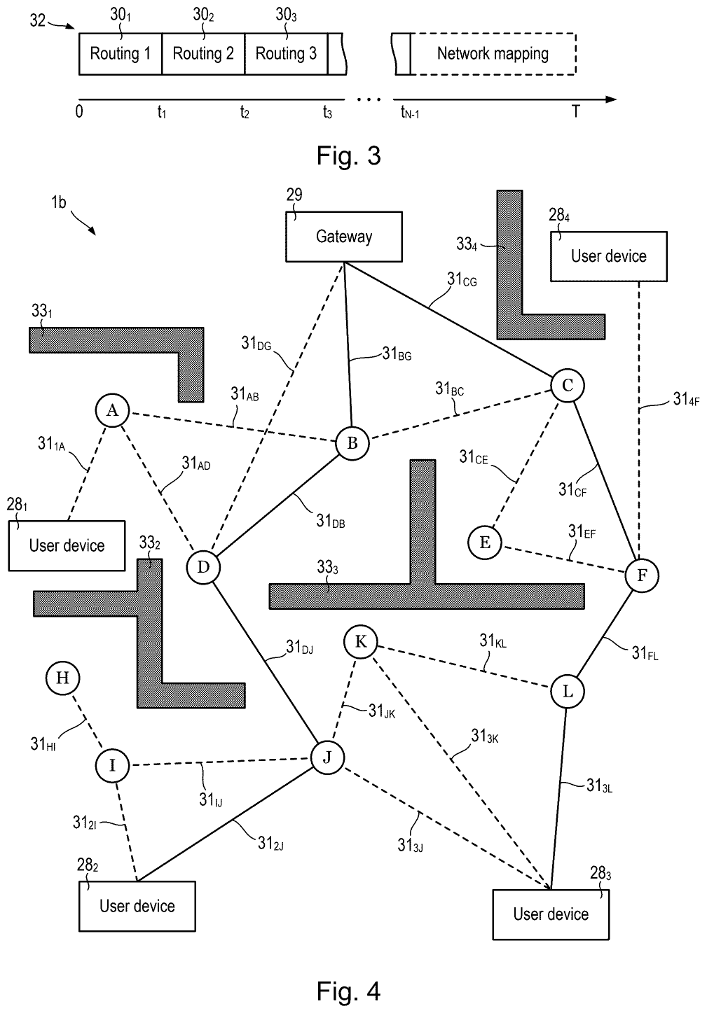

However, the use of the analog signal path 7 for relaying signals, without intermediate down-conversion or processing etc., means that the radio signals 3 being relayed cannot themselves provide addressing/routing information needed by the radio 2 to steer the first transceiver 4 and route the radio signal 3 towards an intended destination. In the radio 2 of the present specification, this is accomplished by the radios 2 communicating and coordinating via the wireless network 26 accessed using the control transceiver 6. The radios 2 communicate via the wireless network 26 (in the second frequency band Δf_{cont}) to generate a network map for line-of-sight communications in the first frequency band Δf_{sig}, and to coordinate a time-multiplexed access scheme (see FIG. 3) for orienting the first wireless transceivers 4 (and optionally also second wireless transceivers 5) of each radio 2 to relay radio signals 3. For example, between one or more user devices 28 and a gateway 29 connecting to a further network such as, for example, the Internet, or mobile communications network base station connecting to a wider network, and so forth.

In order to allow communications between radios 2 which may not have line-of-sight to one another, the wireless network 26 operates in the lower second frequency band Δf_{cont}, which should be at frequencies where significant diffraction effects and/or penetration through obstacles (such as walls, glazed windows etc.) remain viable (see also FIG. 10). For example, the wireless network may comply with, for example IEEE 802.11ax-2021 standard published on 19 May 2021, may correspond to a 3G or 4G (with specific reference to most recently published standards as of 1 Sep. 2022).

The first 4 and second 5 wireless transceivers may be configured as described in WO 2022/157479 A1, the entire contents of which are incorporated herein by the reference. In some embodiments, the first 4 and second 5 wireless transceivers may be configured for analog signal relaying as described in relation to FIGS. 10, and/or 21 to 23 of WO 2022/157479 A1.

Each radio 2 is configured to coordinate with the other radios 2 in the system 1 via the wireless network 26 to control the first 4 and second 5 transceivers to determine a network map for relaying radio signals 3 within the first frequency band Δf₁. For example, referring again to FIG. 1, after generating a network map of the illustrated system 1, a number of line-of-sight (LOS) links 31 are indicated. The subscripts of LOS links 31 indicate the elements they connect between, for example LOS link 31_{AC} connects first and third radios 2_{A} and 2_{C}, whilst LOS link 31 ID connects a first user device 28 to the fourth radio 2_{D} and LOS link 31_{AG} connects the first radio 2_{A} to the gateway 29.

FIG. 1 illustrates the network map in terms of the LOS links 31. For example, the third radio 2_{C} has LOS links 31_{1C} and 31_{2C} to receive from both user devices 28₁, 28₂, and also from the fourth radio 4_{D} via LOS link 31_{CD}. The third radio 2_{C} has onward LOS link 31_{AC} to transmit to the first radio 2_{A}, but does not have a LOS link 31 to the second radio 2_{B} because LOS is blocked by LOS-blocking object 33. Although described as uni-directional, LOS links in the preceding example, LOS links 31 may be bi-directional (or duplex) depending on the configuration of the linked radios 2 (examples of radios 2 configured for bi-directional relaying are included hereinafter).

LOS blocking objects 33 may take the form of any object, or portion of an object, which blocks or attenuates radio signals 3 in the first frequency band Δf_{sig}. LOS blocking objects 33 may include, without being limited to, a building or other structure; internal or external walls, windows, floors and/or ceilings of a building or other structure; vehicles such as trucks, cars and so forth; vegetation such as trees; and so forth.

Particular methods for determining the network map of LOS links 31 are described hereinafter (see for example FIG. 11 and associated description). It may be noted that the low frequency Δf_{cont} wireless network 26 accessed via the control transceivers 6 also conducts network mapping and routing. However, in contrast to the signal relaying in the first frequency band Δf_{sig}, network mapping in the wireless network 26 is conventional (e.g., according to IEEE 802.11ax-2021 s) and shall not described herein for brevity.

Each radio 2 is further configured to coordinate with the other radios 2 in the system 1 via the wireless network 26 to determine one or more time-multiplexed routing configurations 30 (FIG. 3) of that radio 2. In order to assist with network mapping and calculations of routing configurations 30, user devices 28, gateways 29, and any other devices to which radio signals 3 in the first frequency band 4f₁ are to be relayed to/from, should preferably also be connected to the wireless network 26 via compatible transceivers (not shown).

Referring also to FIG. 3, time-multiplexed access scheme 32 for a radio 2 is schematically illustrated.

A total period has duration T, and is divided into a number N of separate sub-period periods. Each period may correspond to a particular routing configuration 30. During a time period corresponding to a time-multiplexed routing configuration 30, the radio 2 is configured to steer the first transceiver 4 to a respective first configuration direction φ₁ corresponding to, i.e., directed towards, one of the other radios 2.

For example, referring again to FIG. 1, in the first radio 2_{A} is illustrated configured with a routing configuration (e.g., during times 0 to t₁) to relay signals from the third radio 2_{C} to the gateway 29 (in FIG. 1, LOS links 31 being used to relay radio signals 3 are illustrated with solid lines). The LOS links 31 not actively being used to relay radio signals 3 are illustrated with dashed lines in FIG. 1. This may be achieved through coordination such that the fourth radio 2_{D} does not re-transmit received radio signals 3 during this time period (for example, by switching off power to amplifiers for transmission). Additionally or alternatively, if the first radio 2_{A} has an electronically steerable second transceiver 5_{A}, then the first radio 2_{A} may be configured to aim the second transceiver 5_{A} at the third radio 2_{C} so that radio signals 3 originating from there are enhanced compared to radio signals arriving from other directions. Synchronization of clocks 15 to maintain timings across the system 1 may be coordinated via the wireless network 26.

In a subsequent sub-period (for example times t₁ to t₂), the first radio 2_{A} instead receives from the fourth radio 2_{D} whilst continuing to relay to the gateway 29. In other words, two or more (or even all) of the time-multiplexed routing configurations 30 may be identical for a given radio, since the routing configurations 30 are calculated for the system 1 overall.

Optionally, the duration T of the total period may also include additional periods. For example, a period t_{N-1} to t_{N} of each total period may be left for conducting network mapping tasks, for example as described hereinafter in relation to FIG. 11.

Referring also to FIG. 4, a second example of a system 1b including eleven radios 2_{A}, 2_{B}, . . . , 2_{L} is schematically illustrated in relation to four LOS-blocking objects 33₁, 33₂, 33₃, 33₄ and four user devices 28₁, 28₂, 28₃, 28₄ which it is desired to connect with a gateway 29. Note that subscript “G” is skipped over for the eighth radio 2 to avoid ambiguity with the gateway 29, for which subscript “G” has already been used.

FIG. 4 illustrates a determined network map, in the form of LOS links 31, for relaying radio signals 3 in the first frequency band Δf_{sig}. An exemplary time-multiplexed access scheme 32 allowing all four user devices 28₁, 28₂, 28₃, 28₄ to communicate with the gateway 29 shall be described. The scheme described is for explanatory purposes only, and is not unique (i.e., other routing configurations could also be employed using the same network map). Links 31 are assumed to be bi-directional for the purposes of describing the exemplary time-multiplexed access scheme 32, and the angles drawn are entirely schematic.

The exemplary time-multiplexed access scheme 32 includes N=2 sub-periods, and the gateway 29 is capable of receiving from at least two sources concurrently. During a first sub-period, the first 28₁ and fourth 28₄ user devices are not connected to the gateway 29, the second user device 28₂ is connected to the gateway 29 via (in order) radios 2_{J}, 2_{D} and 2_{B}, and the third user device 28₃ is connected to the gateway 29 via (in order) the radios 2_{L}, 2_{F} and 2_{C}. For brevity, let connection between the second device 28₂ and the gateway be denoted as 2-J-D-B-G, the connection between the third device 28₃ and the gateway as 3-L-F-C-G, and the configuration of the first sub-period as:

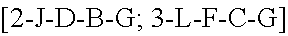

This first sub-period is illustrated in FIG. 4 using solid lines for the active connections. The first 28₁, and fourth 28₄ user devices are able to communicate with the gateway 29 during a second sub-period, which uses for example the configuration of paths:

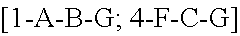

By alternating these two configurations, all four user devices 28₁, . . . , 28₄ may communicate with the gateway 29, despite none having direct LOS to the gateway 29.

The radios 2 do not receive, down-convert and process information from the radio signals 3 which are relayed (although optionally they may in addition to relaying via the analog signal path 7). Instead, each acts more like a programmable “pipe” which has at least a steerable output provided by steering the first transceiver 4. Preferably, the second transceivers 5 are also steerable, allowing each radio 2 to be configured to receive from a particular “source” radio 2 and to relay signals to a particular “target” radio 2, during each routing configuration 30.

For example, in the described example access scheme 32, radio 2_{B} cycles between two routing configurations, e.g., stored local in a table:

| Routing configuration | Source | Target |
|---|---|---|
| 1 | D | G |
| 2 | A | G |

Radio 2_{B} will also store locally a routing table (or equivalent structure) including first φ₁ and second φ₂ angles corresponding to each possible source and target radio(s) 2, gateway(s) 29 and/or user device(s) 28.

In general, more than one path may be available to connect two points in the network map formed by the determined LOS links 31. Routings should preferably be calculated to minimize the number of sub-periods in the access scheme 32, in order to allow the longest possible transmission windows.

The methods for determining the LOS links 31 forming the network map for relaying radio signals 3 in the first frequency band Δf_{sig} is described hereinafter in relation to FIG. 11. However, once the network map and corresponding steering angles φ₁, φ₂ have been determined, the routing configurations 30 may then be determined in any suitable manner. For example, the determination of the time-multiplexed routing configurations 30 for each radio 2 without a system 1, 1b may be based on a dynamic routing method such as, for example, a distance-vector routing protocol, a link-state routing protocol and so forth.

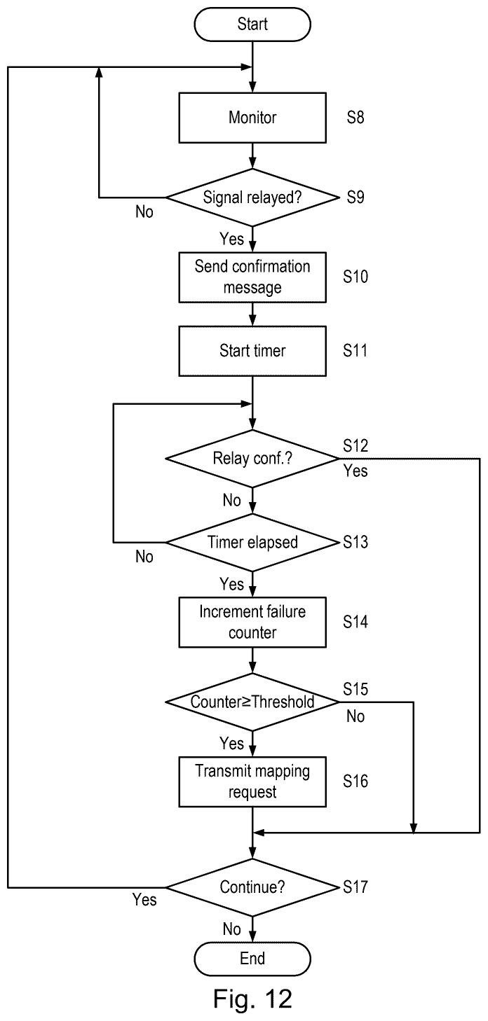

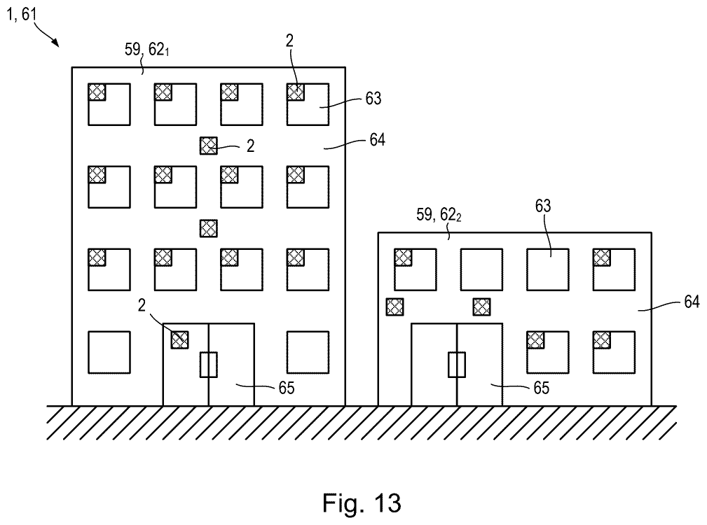

Each radio 2 may be configured to coordinate with the other radios 2 belonging to the system 1 to determine a network map according to a pre-set schedule. For example, after cycling through a predetermined number of periods T (for example a hundred or more). Additionally or alternatively, each radio 2 may be configured to coordinate with the other radios 2 belonging to the system 1 to determine a network map in response to a triggering event. For example, a mapping request message generate in response to a new radio 2 joining the wireless network 26, in response to one of the radios 2 leaving the wireless network 26, in response to a radio 2 reporting that a LOS link 31 stored in its local routing table is no longer responsive (see for example FIG. 12), and so forth.

Some or all of the radios 2 may be configured to transmit steering data to one or more of the other radios 2 in the system (via the wireless network 26), to provide additional inputs for network mapping. Steering data may include one or more of a location of the radio 2, for example a GPS location, a velocity of the radio, and an acceleration of the radio 2 (for example from and a bearing of the radio 2. The radios 2 may be configured to exchange steering data via the wireless network. This may be useful when one or more of the radios 2 is mobile, for example mounted to a vehicle.

Each user device 28 includes a wireless transceiver for the first frequency band Δf₁. Whilst the radios 2 may simply listen for radio signals 3 transmitted from user devices 28, it is preferable that user devices 28 also connect to the system 1 via the wireless network 26 so that they may be coordinated with the radios 2 to perform network mapping and/or routing configurations in an analogous manner to the radios 2. In other words, with the exception of not requiring a second wireless transceiver 5 and an analog signal path 7, and being a start/end point for radio signals instead of relaying, user devices 28 may include any features or functions of the radios 2 described herein. In this way, when referring to functions of a radio 2 other than relaying, this should be read to include user devices 28, gateways 29, and any other devices which may be connected to transmit and/or receive radio signals 3 in the first frequency band Δf₁ via the radios 2.

Examples of user devices 28 may include, without being limited to, a mobile phone/smartphone, a tablet computer, a smart watch, a laptop computer, and so forth. One, some or all of the user devices may be configured to transmit and/or received steering data of the types described hereinbefore.

In other examples, some or all user devices 28 may additionally function as radios for relaying radio signals 3. This may be done by providing user devices 28 with analog signal paths 7 analogous to the radios 2. However, since the user devices 28 will generally be configured to down-convert and interpret radio signals 3, user devices 28 could be used to provide more conventional relaying of radio signals 3 (e.g., by down-converting, decoding, interpreting, then re-transmitting).

The processing to determine the network map and the one or more time-multiplexed routing configurations 30 for each of the radios 2 is carried out by a subset of one or more of the radios 2. For example, some of the radios 2 may be fitted with more powerful processors 13 and expanded memory 14, and may perform mapping and routing coordination over a sub-region of the system 1. Such radios 2 may then transmit routing configurations 30 for each radio 2 in the sub-region to that radio 2 over the wireless network 26.

The system may also include one or more control nodes (not shown), each communicatively coupled to two or more of the radios 2. Each control node (not shown) may be configured to coordinate network mapping and/or routing by the corresponding radios 2, and should be communicatively coupled to those radio 2 via a wired network and/or the wireless network 26. In some examples, control nodes may also be radios 2, but equally in other example control nodes may provide coordination functions without also relaying radio signals 3.

Alternatively, the processing to determine the network map and the one or more time-multiplexed routing configurations 30 for each of the radios is distributed in parallel across two or more, or even all, of the radios 2.

### Concurrent Bi-Directional Relaying

Referring, for example, to FIG. 2, the radio 2 shown may be adapted for simultaneous bi-directional (duplex) relaying of radio signals 3 by duplicating the first 4 and second 5 wireless transceivers and the analog signal path 7.

In other words, by including third and fourth transceivers (not shown) for the first frequency band Δf₁. The third transceiver should be electronically steerable to a third direction (not shown), and configured the same as the first transceiver 4 except that it is directed in generally the same direction as the second transceiver 5. Similarly, the fourth transceiver should be same as the second transceiver 5 except that it is directed in generally the same direction as the first transceiver 4. The second analog signal path (not shown) should be configured the same as the analog signal path 7, except that it relays radio signals 3 received by the fourth transceiver to the third transceiver (again without down-conversion or digitization), and retransmits the radio signal 3 using the third transceiver. A radio modified in this way could be configured, during a time period corresponding each time-multiplexed routing configuration 30, to steer the third transceiver, and optionally the fourth transceiver if electronically steerable, so as to relay radio signals 3 in the opposite direction to the first 4 and second 5 transceivers. In other words, the source radio for the fourth transceiver is the target radio of the first transceiver 4, and the target radio for the third transceiver is the source radio of the second transceiver 5.

Alternatively, the third and fourth transceivers (not shown) may be oriented independently of the first 4 and second 5 transceivers, allowing a radio 2 to form a junction in two different relaying paths at the same time.

### Time-Multiplexed Bi-Directional Relaying

An alternative approach to bi-directional relaying is to time multiplex the direction of relaying. For example, a radio may be configured to relay radio signals 3 received by the second transceiver 5 to the first transceiver 4 via the analog signal path 7 and to retransmit the radio signals 3 using the first transceiver 4 during some time-multiplexed routing configurations 30. During other time-multiplexed routing configurations the radio 2 is configured to instead relay radio signals received by the first transceiver 4 to the second transceiver 5 via the analog signal path and to retransmit the radio signal 3 using the second transceiver 5 for retransmission.

This approach may reduce the amount of duplication needed for bi-directional communication, although both relaying in directions will entail low noise amplifiers for received signals and power amplifiers for retransmission at both ends of the analog signal path 7. Nonetheless, the need to duplicate the antennae of the first 4 and second 5 transceivers is avoided.

### Directional Configurations of Radios

Radios 2 have been described hereinbefore as having:
An electronically steerable first transceiver 4 and a wide-angle second transceiver 5; or
Both first 4 and second 5 transceivers are electronically steerable.

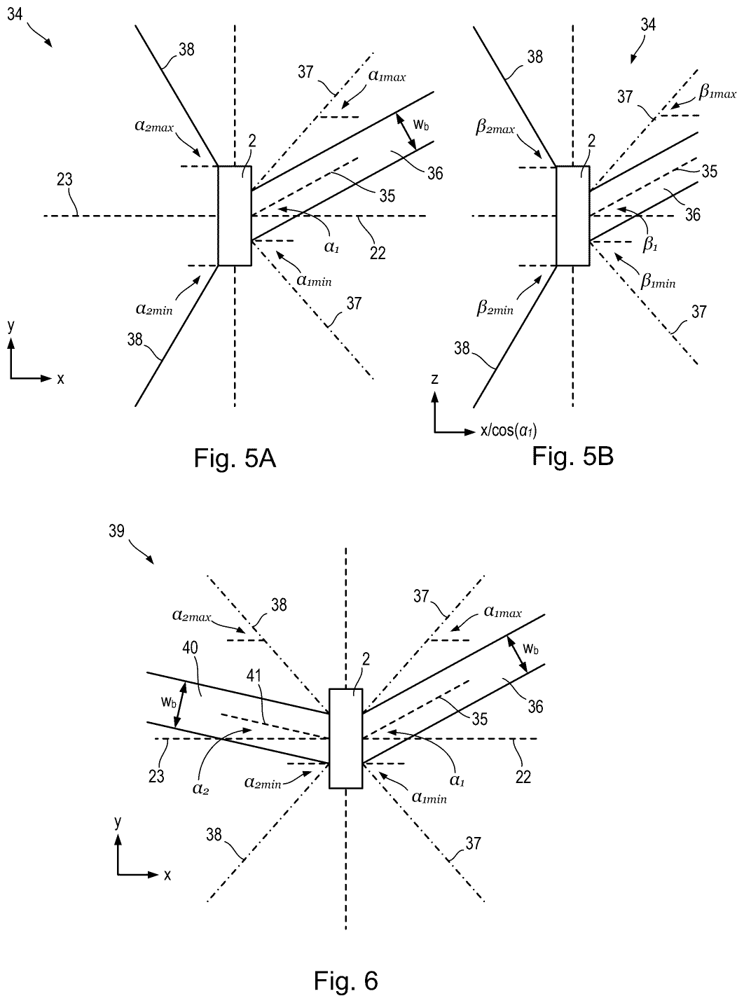

Referring also to FIGS. 5A and 5B, a first directional configuration 34 is shown. The horizontal axis of FIG. 5B is rotated about the z-axis relative to the x-axis of FIG. 5_{A} by an angle α₁ shown in FIG. 5B.

The first angle (direction) φ₁ to which the first transceiver 4 is steered is a 3D angle, which for the clarity of following discussions may be defined in terms of a first longitudinal angle α₁ and a first latitudinal angle β₁ in a coordinate system defined relative to the radio 5. The first angle φ₁=(α₁, β₁) represents the angle between a first Poynting vector 35 and the first reference direction 2. The first Poynting vector 35 corresponds to a maximum power of a main lobe of the first transceiver 4, which is ideally in the form of a first beam 36 of width w_{b}. In practice, the first beam 36 will diverge (w_{b} increases) with distance from the radio 2, though preferably the divergence over the typical distances between radios 2 of the system 1 should preferably be minimized. In the illustration of FIG. 5_{A}, the first reference direction 22 corresponds to the illustrated x-axis, the first longitudinal angle α₁ is defined between the first reference direction 22 and a projection of the first Poynting vector 35 onto the x-y plane, and the first latitudinal angle β₁ is defined between the first Poynting vector 35 and the x-y plane, in a plane parallel to the z axis as illustrated.

The first angle φ₁ is bounded by a first angular range 37. In other words, the first angle φ₁ is steerable to orient the first Poynting vector 35 (i.e., main lobe) of a corresponding radiation pattern within the first angular range 37. For example, the first angular range may correspond to −α₁ₘᵢₙ≤α₁≤α₁ₘₐₓ and −β₁ₘᵢₙ≤β₁≤β₁ₘₐₓ. Constant angular limits may be a reasonable approximation for some first transceivers 4, but in some cases the longitudinal limits may be a function of latitude, i.e., α₁ₘᵢₙ(β₁), α₁ₘₐₓ(β₁), and vice versa β₁ₘᵢₙ(α₁), β₁ₘₐₓ(α₁).

In the first directional configuration 34, the second transceiver 5 has a main lobe of the corresponding radiation pattern corresponding to a second angular range 38, defined relative to coordinates aligned with the second reference direction 23 in analogous manner to the first transceiver 4. In the example illustrated in FIGS. 5A and 5B, the first 22 and second 23 directions correspond to opposite directions parallel to the illustrated x-axis. The second angular range 38 represents the sensitivity of the second transceiver 5 to detect radio signals 3 incident along an angle φ₂=(α₂, β₂) relative to the second reference direction 23. In practice, the second transceiver 5 will have variable sensitivity to all incidence angles φ₂=(α₂, β₂) within the second angular range 38, i.e., −α₂ₘᵢₙ≤α₂≤α₂ₘₐₓ and −β₂ₘᵢₙ≤β₂≤β₂ₘₐₓ. In some examples, the second angular range 38 may be defined by the angles outside of which sensitivity to incident radio signals 3 drops below a specified threshold (for example 50% in power) of a normalized value corresponding to the second reference direction 23 (α₂=0, β₂=0).

Although illustrated with equal beam width w_{b} in longitudinal and latitudinal directions, in practice the dimensions and cross-section shape of the first beam 36 may be different in different directions and/or may vary with central angle φ₁.

Referring also to FIG. 6, a second directional configuration 39 is shown.

The second directional configuration 39 is the same as the first direction configuration 34, except that the second transceiver 5 is also steerable to a second beam 40 having second Poynting vector 41.

Although illustrated with equal beam widths w_{b} for first 36 and second 40 beams, reflecting the preference that when the second transceiver 5 is steerable it is similar or identical to the first transceiver 4, this is not essential.

The direction configurations 34, 39 have been illustrated with the first 22 and second 23 reference directions oriented in opposite senses along the same axis, this is not essential, and in general the first 22 and second 23 reference directions may be oriented at any angle between 180° and 0° to one another. In some examples, the first 37 and second 38 angular ranges may overlap, although in some applications overlap may be undesirable and may be avoided.

### Switchable Radiation Patterns

Either or both of the first 4 and second 5 transceivers may be switchable between operating in a first mode corresponding to a radiation pattern comprising a beam 36, 40 which is electronically steerable to the respective direction φ₁, φ₂, and a second mode corresponding to reception of signals from a broader angular distribution, for example the respective angular range 37, 38. For example in the first directional configuration 34 of FIGS. 5A and 5B, the first transceiver 4 is in the first mode and the second transceiver is in the second mode. In the second directional configuration 39 of FIG. 6, both first 4 and second 5 transceivers are operating in the first mode.

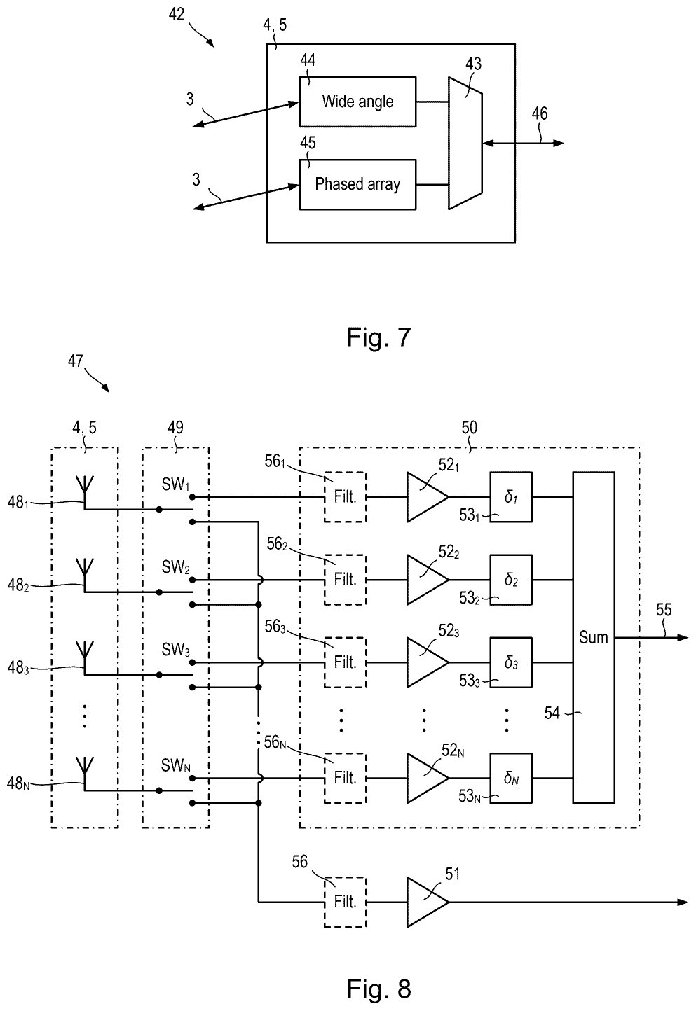

The switching may be accomplished in two main ways. Referring also to FIG. 7, a first switching configuration 42 is shown.

In the first switching configuration 42, the first and second modes correspond to switching between different antennae or arrays of antennae. The first 4 and/or second 5 transceiver may include a switch 43 selecting between a wide-angle antenna (or antenna array) 44 and a phased antenna array 45. In this way, an input/output 46 to a transceiver 4, 5 may be switched between wide-angle and steerable reception/transmission.

Referring also to FIG. 8, a second switching configuration 47 is shown. The second switching configuration is illustrated for a receiver-side, however the adaptation to the transmission side is readily apparent.

In the second switching configuration 47, the first and second modes correspond to the same antennae or arrays of antennae. The transceiver 4, 5 includes an array of a number N of antennae 48₁, 48₂, . . . 48ₙ, . . . , 48_{N} (each of which may be an antenna array). The output of each antenna 48ₙ is switchable, via a respective switch SWₙ of a switching block 49, between a beamforming block 50 and a common amplifier 51 (optionally via one or more filters/filter banks 56). The beamforming block 50 includes a channel corresponding to each antenna 48ₙ, each channel includes a respective channel amplifier 52ₙ and a phase-shifter 53ₙ which applies a phase shift δₙ. The outputs of each phase shifter 53₁, . . . , 53_{N} are summed by a summer 54 to provide a beamformed output 55. Each channel may also include one or more filters/filter banks 56ₙ. The phase shifts δₙ are controllable (for example using beamforming module 19 of the controller 8), to steer the beam 36, 40 to a desired direction φ₁, φ₂.

In the first mode, the antennae 48₁, . . . , 48_{N} are controlled as a phased array by connecting the switches SW₁, . . . , SW_{N} to the respective channels of the beamforming block 50 to provide the beamforming output 55. In the second mode, some or all of the antennae 48₁, . . . , 48_{N} are switched to connect to the common (or summing) amplifier 51, the output of which has reduced directional dependence compared to the beamforming of the first mode. The common amplifier 51 may also have a relatively higher gain than any channel amplifier 52ₙ used during the first mode. In other examples, there may be more than one common (or summing) amplifier 51, each corresponding to a subset of the antennae 48₁, . . . , 48_{N}.

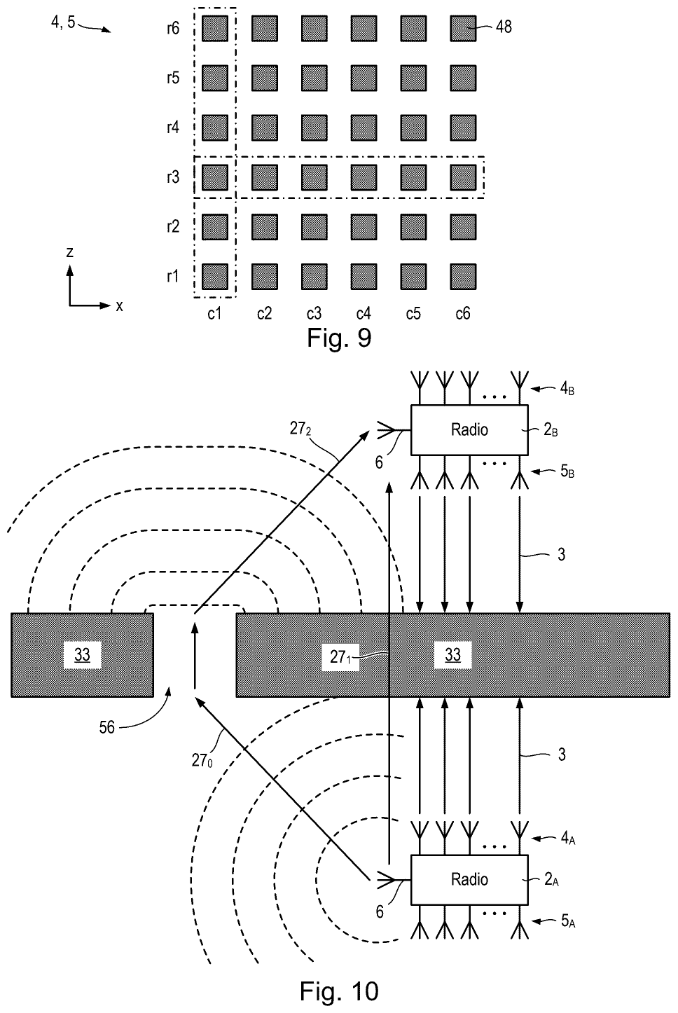

Referring also to FIG. 9, an example of a layout for a phased array of planar antennae 48 is shown.

The antennae 48 are arranged into a square (or rectangular grid) with rows r1, . . . , r6 and columns c1, . . . , c6 (the precise numbers of rows and columns are not important, and need not be equal). The antennae 48 take the form of planar antennae in the illustrated example. The regular spacing of antenna element and finite impedance between each antenna 48 and the adjacent antennae means that simply summing the outputs of each antenna 48 using the common amplifier 51 may still result in angular dependence of sensitivity. This may be mitigated in the second mode by summing outputs from a subset such as a single row r1, . . . , r6 or a single column c1, . . . , c6, as illustrated by chained outlines in FIG. 9. For example, summing column c1 would result in angular dependence in latitudinal 8 response, yet substantially wide-angle (or even omnidirectional) response in longitudinal a directions. Summing a row, e.g., r3 as illustrated, provides the same function with latitude and longitude reversed. In many applications/installations, a given radio 2 may only need a wide-angle response in one direction.

### Coordination Between Radios to Establish LOS Links

Referring also to FIG. 10, a pair of radios 2_{A}, 2_{B} is shown separated by a LOS blocking object 33.

Radio signals 3 in the first frequency band Δf₁ are high frequency, for example 5 GHz or greater. As the frequency is increased, absorbance in materials such as buildings and/or from the environment (in particular water) increases. Additionally, there is diffraction around obstacles compared to lower frequency radio signals having wavelengths closer to the scale of buildings and other obstacles. As illustrated in FIG. 10, radio signals 3 in the first frequency band Δf₁ are blocked, and the radios 5_{A}, 5_{B} are unable to communicate with one another.

A LOS-relaying network may be designed and installed and configured based on knowledge of the sizes and relative positions of LOS blocking obstacles 33. However, this is time consuming and inflexible to any changes in the environment. It would be preferable if radios 2 could be installed and then conduct dynamic network mapping to determine which other radios 2 a particular radio 2 has LOS links 31 with. Such a process requires timing and coordination between the radios 2, and communications in the desired first frequency band Δf₁ are unsuitable because of the LOS issue. In the present specification, the solution is proposed of using radios 2 which communicate via a wireless network 26 operating in lower, second frequency range Δf₂.

The second frequency range Δf₂ should be selected such that control and coordination messages 27 broadcast over the wireless network 26 may penetrate through (27₁) and/or be diffracted around (27₂) LOS blocking obstacles 33. For example, at some frequencies, a control and coordination message 270 transmitted by a first radio 2_{A} in the second frequency range Δf₂ may be transmitted 27₁ through a LOS blocking obstacle 33. There will be some attenuation, but if the control transceiver 6 of the receiving, second, radio 2_{B} can resolve the signal above the noise, then there is transmission. Similarly, at lower frequencies (compared to the first frequency range Δf₂), there may additionally or alternatively be diffraction around corners of/through gaps 57 in the LOS blocking obstacle 33, leading to detectable diffracted signals 27₂ at the second radio 2_{B}.

In this way, the radios 2 of the present specification may be aware of one another, and may coordinate to implement the methods described herein, using the wireless network 26 operating in the second frequency range Δf₂.

### Network Mapping Method

Referring also to FIG. 11, a method of mapping the LOS links 31 between radios 2 in the system 1 is illustrated.

The start of network mapping (step S1) is coordinated (i.e., synchronized) between all the radios 2, or at least a subset of radios 2 corresponding to a particular sub-region (for example a street or a building) of the system. The network mapping process may be carried out according to a schedule and/or in response to a request message generated in response to, for example, detecting a change in the map of the wireless network 26 (due to a radio 2 joining or leaving), or in response to detecting a broken LOS link 31 (see also the method illustrated in FIG. 12).

During the network mapping process, each radio 2, or at least each radio belonging to a subset to be mapped, is assigned a timeslot for broadcasting test signals (step S2). When a radio 2 is not transmitting, it is set to a listening mode (step S3). The test signal 24 may encode a unique identifier of the radio 2ₙ, for example, the unique identifier may be encoded by modulating the frequency and/or amplitude of the test signal 24, or the unique identifier may correspond to using a particular carrier frequency for the test signal 24. Alternatively, the identity of a radio 2ₙ sending a test signal 24 may be determined by correlating a time of reception to the timeslot allocations for sending test transmissions.

Referring again to FIG. 2, the radio 2 may include the test transmission channel 20 coupled to the analog signal path 7 and configured to inject the test signal 24 for transmission by the first transceiver 4. For example, the test transmission channel 20 may be coupled to the analog signal path 7 using one or more switches, and the radio 2 may be configured to disconnect the test transmission channel 20 from the analog signal path 7 when not in use.

During the corresponding timeslot, each radio 2, for example the n^{th} radio 2ₙ of N radios 2₁, . . . , 2_{N}, transmits a test signal 24 using its first transceiver 4ₙ, whilst scanning the first direction φ₁ through a range of available angles φstep S4). For example, the first transceiver 4 may continuously transmit the test signal 24 whilst performing a raster scan of the first beam 36 through the longitudinal angles α₁ₘᵢₙ≤α₁≤α₁ₘₐₓ and latitudinal angles β₁ₘᵢₙ≤β₁≤β₁ₘₐₓ spanning the first angular range 37. Due to the finite beam width w_{b}, every possible angle does not need to be scanned, provided there is sufficient overlap. For example, after scanning all longitudinal angles α₁ₘᵢₙ≤α₁≤α₁ₘₐₓ at a given latitudinal angle β₁, the latitudinal angle β₁ may be shifted by an amount Δβ corresponding to a fraction of the beam width w_{b}, for example 75%, 50%, 25% and so forth, before repeating the scan of the longitudinal angles α₁ₘᵢₙ≤α₁≤α₁ₘₐₓ. Similarly, the scanning of longitudinal angles α₁ₘᵢₙ≤α₁≤α₁ₘₐₓ need not be continuous, provided that there is sufficient overlap of the beam width wp between adjacent scan directions φ₁ to ensure that a potential receiving radio is not missed.

Radios 2 in the listening mode (step S3) are configured to listen, using the respective second transceiver 5, for more test signals 24 transmitted by other radios 2. In the example shown in FIG. 11, radios 2ₖ₁, 2ₖ₂ in FIG. 11 (with k1≠k2≠n) receive the test signal 24 transmitted by the n^{th} radio 2ₙ at different times. Since they are not in the same position, the k1^{th} and k2^{th} radios 2ₖ₁, 2ₖ₂ receive the beam 36 at different times during the scan. To avoid false positives, confirming detection of the test signal 24 may require the received test signal 24 to exceed a threshold signal level, such as, for example, a threshold power, or a threshold amplitude. The threshold signal level may be set to a multiple of a standard error of noise on the second transceiver 5 output of the receiving radio 2ₖ₁, 2ₖ₂, for example, three times the standard error. The standard error corresponding to each radio 2 may be pre-calibrated, calibrated upon installation, and/or periodically updated during use. In this way, a LOS link 31 is determined to exist if the strength of the incident test signal 24 exceeds the threshold signal level.

Referring again to FIG. 2, each radio may also include a receiver channel 21 coupled to the analog signal path 7 and configured to obtain a sampling 25 of received signals. The sampling 25 may be used to detect test signals 24 during network mapping procedures. The receiver channel 21 may include one or more of a frequency analyzer, a pulse analyzer, and so forth. In this way, whilst the receiver channel 21 and the radio 2 do not need to (and generally would not be configured to) be able to extract and process data packets of radio signals 3 relayed via the analog signal channel 7, it is possible to detect the presence or absence of a received signal. In other words, the receiver channel need only be configured for coarse resolution in time and frequency, and is not intended to be used to extract or process data packets being relayed in the first frequency band Δf₁. The receiver channel 21 may be coupled to the analog signal path 7 using one or more switches (not shown), and the radio 2 may be configured to disconnect the receiver channel 2₁ from the analog signal path 7 when not in use.

When the second transceiver 5 is also electronically steerable, the process of listening (step S3) for test signals may also include scanning the second direction φ₂ through the second angular range 38. In such cases, the scan rate of second directions φ₂ by listening radios 2 (e.g., 2ₖ₁, 2ₖ₂) and the scan rate of first directions φ₁ by transmitting radio(s) 2 (e.g., 2ₙ) should be coordinated such that listening radios 2 (e.g., 2ₖ₁, 2ₖ₂) will be able to complete a scan of the respective second angular range 38 during an expected dwell time of a first beam 46 from the transmitting radio(s) 2 (e.g., 2ₙ). A typical dwell time may be estimated based on, for example, a beam width w_{b} of the first beam 36, a slew rate of the first angle φ₁ and a size of the second transceivers 5 of the radios 2. In this way, the chances of missing detection of an incident first beam 36 may be reduced.

When the second transceiver 5 is operable in a first, directional mode and a second, wide-angle (or omnidirectional) mode (for example as described in relation to FIGS. 7 to 9), during the listening mode (step S3) a radio 2 (for example 2ₖ₁, 2ₖ₂) may be configured to operate the second transceiver 5 in the second mode, in order to more easily detect an incident test signal 24. In this way, a directional mode may be used during relaying, whilst a wide-angle mode is used during network mapping, allowing faster scanning of the first angle φ₁ of a transmitting radio 2 (e.g., 2ₙ) because the second angle φ₂ on the receiver side does not require scanning.

In response to receiving a test signal 24 from a transmitting radio 2ₙ, a listening radio 2ₖ₁, 2ₖ₂, the listening radio 2ₖ₁, 2ₖ₂ processes the test signal (step S5) and transmits a LOS confirmation message 58 to the transmitting radio 2ₙ via the wireless network 26. The LOS confirmation message 58 is an example of a control and coordination message, and includes an identifier of the listening radio 2ₖ₁, 2ₖ₂, and a reception time t_{rec} corresponding to a maximum received signal (e.g., power/amplitude) of the test signal 24. In other words, the reception time t_{rec} corresponds to the best estimate of when the first beam 36 is centered on the receiving second transceiver 5. For the purpose of routing the LOS confirmation message 58 via the wireless network 26, the source of the test signal 24, i.e., the transmitting radio 2ₙ, may be determined based on a unique identifier of the transmitting radio 2ₙ encoded in the test signal 24, or by comparing the reception time t_{rec} against a schedule defining when the timeslots during which each radio 2 (e.g., 2ₙ) is scheduled to transmit test signals (steps S2 onwards illustrated for transmitting radio 2ₙ in FIG. 11).

Simultaneously with transmitting the test signal 24 and scanning the first direction φ₁, a transmitting radio 2ₙ listens, via the wireless network 26, for one or more LOS confirmation messages 58 transmitted by the listening radios 2ₖ₁, 2ₖ₂. In response to receiving a LOS confirmation message 58 from one of the listening radios 2ₖ₁, 2ₖ₂, the confirmation is logged (step S6). The listening radio 2ₖ₁, 2ₖ₂ which sent the LOS confirmation message 58, identified by the identifier included in the message 58, is added to a routing table stored (for example in storage 17) by the transmitting radio 2ₙ, along with the first direction φ₁ pointing to that radio 2ₖ₁, 2ₖ₂. The corresponding first direction φ₁ is determined based on correlating the reception time t_{rec} from the LOS confirmation message 58 to the first direction φ₁ at that time. In this way, the routing table take the form of a list of other radios 2 to which a given radio 2ₙ has LOS links 31, and the corresponding first directions φ₁. Optionally, each LOS confirmation message 58 may also include a quality metric, for example a signal strength or other measure of quality. The routing table may also include the quality metric corresponding to each respective LOS link 31 (connection), and the quality metric may be used as an input when determining routing configurations 30.

Once a given transmitting radio 2ₙ has finished sweeping its test signal 24 through the corresponding first angular range (step S7), the process is repeated for each other radio 2 in the system 1, or at least each radio 2 belonging to a subset of the system 1 currently being mapped.

The network map may be formed by aggregating the routing tables (defining the LOS links 31) of each radio 2 in the system 1 (i.e., all radios 2 communicatively coupled to the wireless network 26). In addition to each radio 2 storing a local routing table for itself, the system may additionally store copies of each local routing table at a centralized location, for example, one of the radios 2 or an additional device (not shown) communicatively coupled to the wireless network. Each radio 2 may broadcast copies and/or updates to its local routing table to one or more other radios 2 via the wireless network 26, and each radio 2 may store local copies of the routing table(s) corresponding to some or all of the other radios 2 in the system 1. In some examples, a complete network map may be distributed to each radio 2 for storage of a local copy.

Once the network map of LOS links 31 has been compiled, routing may then be conducted using conventional network routing methods.

Although described in relation to mapping connections between first transceivers 4 of a transmitting radio 2ₙ and second transceivers 5 of listening radios 2ₖ₁, 2ₖ₂, these roles for transceivers 4, 5 are not fixed. In some embodiments, when first 4 and second 5 transceivers are both electronically steerable, a transmitting radio 2ₙ may send the same, or different, test signals from first 4 and second 5 transceivers whilst scanning the respective directions φ₁, φ₂ either simultaneously or one following the other. Similarly, any or all listening radios 2ₖ₁, 2ₖ₂ may listen using either or both of the first 4 and second 5 transceivers.

Although described as being conducting sequentially for each radio 2 to be mapped, the network mapping process need not be conducted in continuous blocks of time. For example, referring again to FIG. 3, each period T may include a network mapping period, and during each period a different radio 2 may take the role of transmitter whilst the other radios 2 listen. In this way, the network map may be continuously checked and updated, without interrupting relaying services as much as mapping all LOS links 31 for every radio 2 one continuously.

### Detecting Broken LOS Links

After network mapping and determination of routing configurations, it may be advantageous to monitor LOS links 31 during normal relaying operation, to detect if any LOS links 31 stop working. In response to detecting a broken LOS link 31, a full or partial network mapping may be triggered (e.g., using the method of FIG. 11). LOS links 31 may stop working for a number of reasons including but not limited to, movement of radios 2, movement of mobile LOS blocking obstacles 33 (for example, a truck or crane), changing atmospheric conditions (rain, fog etc.), failure of a radio 2 or its power supply, and so forth.

Referring also to FIG. 12, a method for a radio 2 to monitor the state of the LOS links 31 utilized by its time multiplexed routing configurations 30 is shown.

The radio 2 monitors the status of relaying through the analog signal channel 7 using the sampling 25 obtained by the receiver channel 21 (step S8). As described hereinbefore, the receiver channel 21 is generally not capable (and need not be) of properly processing or extracting data from radio signals 3 in the first frequency band Δf₁, and instead is used to determine if and when a radio signal 3 is being relayed. Additionally or alternatively, the radio 2 may monitor the power draw of amplifiers used to re-transmit a received radio signal 3 using the first transceiver 4. When a signal 3 is relayed, the power draw of the amplifiers will temporarily increase.

In response to detecting (for example as described in relation to step S8) that a radio signal 3 has been relayed via the first 4 and second 5 transceivers and analog signal path (step S9|Yes), the radio 2 transmits, via the wireless network 26, a control and coordination message 27 in the form of a first relay confirmation message to a source radio 2 corresponding to the currently active time-multiplexed routing configuration 30 (step S10). The first relay confirmation message includes an identifier of the relaying radio 2, which allows the source radio 2 to confirm receipt as described hereinafter. The active time-multiplexed routing configuration 30 will identify which other radio 2 of the system 1 is aimed at the radio 2 at any given time, allowing addressing of the first relay confirmation message to the previous radio 2 in the relaying path.

The radio 2 then starts a timer (step S11) and listens, via the wireless network 26, for a second relay confirmation message to be received from the target radio 2 corresponding to the active time-multiplexed routing configuration 30. The second relay confirmation message is the same as the first relay confirmation message, except that it is sent by the target radio 2 (i.e., the next step in the relaying chain).

If the second relay confirmation message is received (step S12|Yes), then whilst the relaying operation continues (step S17|Yes), the radio 2 returns to monitoring the analog signal channel 7 for activity (step S8).

However, if the predetermined period elapses without reception of the second relay confirmation message (step S13|Yes), then a failure counter corresponding to the target radio 2, or equivalently to the LOS link 31 connecting to that radio 2, is incremented (step S14). For example, a failure counter for each LOS link 31 may be stored in an additional column of the local routing table of a radio 2.

Whilst the failure counter for a LOC link 31 remains less than a broken-link threshold (step S15|No), operation continues without changing the routing table. This is because occasional dropped signals are to be expected, and it may be inefficient to re-map the network of LOS links 31 in response to each and every dropped signal. The broken link threshold may be pre-determined, for example, an integer between three and ten, or may be calibrated and/or adjusted in use.

However, once the failure counter equals or exceeds the broken-link threshold (step S15|Yes), the radio 2 transmits a mapping request message via the wireless network 26 (step S16). The mapping request message is another example of a control and coordination message 27. In response to the mapping request message, the entire system 1 may be remapped, or only a subset of radios 2 including the radio 2 which sent the request (for example, using the method illustrated in FIG. 11).

The failure counter corresponding to a particular target radio 2/LOS link 31 may be reset to an initial value (for example zero) in response to a reset period elapsing without that failure counter being incremented by a relaying failure. The reset period should be at least a few times a total cycling period of the one or more time-multiplexed routing configurations 30. In other words, the failure counter corresponding to a particular target radio 2/LOS link 31 should not be reset until all the routing configurations of the radio 2 have been cycled one or more times without experiencing a failure. In this way, generation of mapping request messages may be restricted to the circumstances that a particular LOS link 31 has failed multiple times in rapid succession. In response, the network map may be checked, and time-multiplexed routing configurations 30 recalculated to route around a broken LOS link 31.

### Example Systems

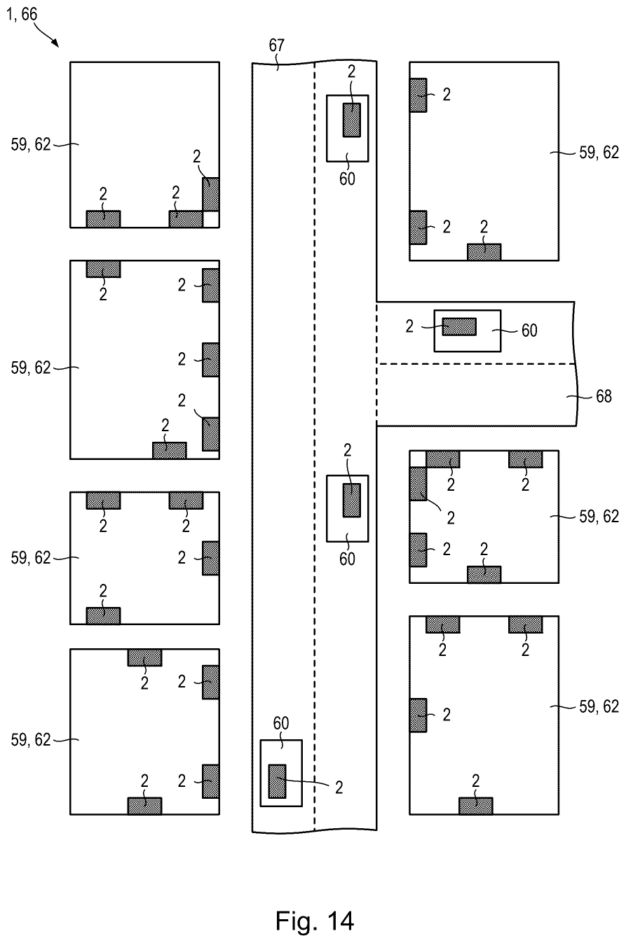

The placement of radios 2 for a system 1 may not be limited and may include one or more radios 2 supported by a structure 59 (FIG. 13), one or more radios supported by a vehicle 60 (FIG. 14), and one or more user devices 28. User devices 28 may also be radios 2, i.e., including first 4 and second 5 transceivers coupled by an analog signal path 7. More often, user devices 28 will include a single transceiver, and will be configured to extract and process data packets from the radio signals 3. Such user devices 28, which do not correspond to radios 2, may still be used for signal relaying, in the more conventional sense of extracting packets (or at least headers thereof), and then re-transmitting radio signals 3 (either directionally or not). Relaying by user devices 28 which do not correspond to radios 2 may be coordinated via the wireless network 26, alongside coordination of mapping the LOS links 31 and time-multiplexed routing configurations 30.

A radio 2 being supported by a structure 59 (FIG. 13) may include attachment to the structure 59, mounting to the structure 59, and so forth. A radio 2 being supported by a structure 59 may additionally or alternatively include radios 2 being incorporated into, or integrally formed with, the structure 59. Radios 2 are not limited to being supported on, or around, the exterior of structures 59, and in many cases it will be desirable to install radios 2 within a structure 59 to extend the coverage for relaying of radio signals 3 throughout the interior of a structure 59.

Referring also to FIG. 13, a first example system 1, 61 is shown. A pair of structures 59 in the form of first and second buildings 62₁, 62₂ are shown.

Each of the buildings 62₁, 62₂ supports a number of radios 2, mounted to windows 63, walls 64 and doors 65 of the buildings 62₁, 62₂. Walls 64 supporting radios 2 may be internal and/or external. Radios 2 may be supported on internal and/or external surfaces of windows 63. Although not shown in FIG. 13, two or more radios 2 may be supported by the same window 63, wall 64 (internal or external), door 65, roof and so forth of a structure 59 such as a building 62. For example, radios 2 supported on internal and/or external surfaces of windows 63 may form part of a system 1 with other radios 2 spread throughout a structure 59 such as a building 62 to allow radio signals 3 to be relayed into, and out from, user devices 28 within the interior of the structure 59 and which would otherwise be unable to send to/receive from the exterior of the structure 59.

Referring also to FIG. 14, a second example system 1, 66 is shown.

The second example system 1, 66 covers a larger area than the first example system 61, including a number of buildings 62 surrounding a T-junction between a road/street 67 and a side road/strect 68. Each of the buildings 62 supports a number of radios 2 which are fixed, and the second example system 1, 66 also includes radios 2 supported by vehicles 60 such as, for example, a car, a bus, a van, a truck, a lorry and so forth. Such mobile radios 2 may be supported a window or a portion of the bodywork of the vehicle 60. Mobile radios 2 may enter the area of the second example system 1, 66, and may also leave (for example joining to a new system 1 not shown installed in an adjacent area). Such changes in both composition and relative locations of radios 2 in the system may be accounted for using the dynamic network mapping (see FIG. 11) and LOS link 31 status monitoring (see FIG. 12) described herein.

In addition to buildings 62 and vehicles 60, radios 2 may also be supported on structures 59 such as a bus shelter (not shown), a lamp post (not shown), or any other item of street furniture in the area of operation.

Finally, when user devices 28 either provide radios 2, or may be coordinated to perform more conventional relaying, user devices 28 may also form part of the system 1 for relaying radio signals 3, instead of being only start/end points for radio signals 3.

Although in FIG. 14 each building 62 is shown as supporting radios 2 around its respective perimeter, each or all of the buildings 62 may (and preferably will) including additional radios 2 distributed to extend the system 1, 66 throughout each building.

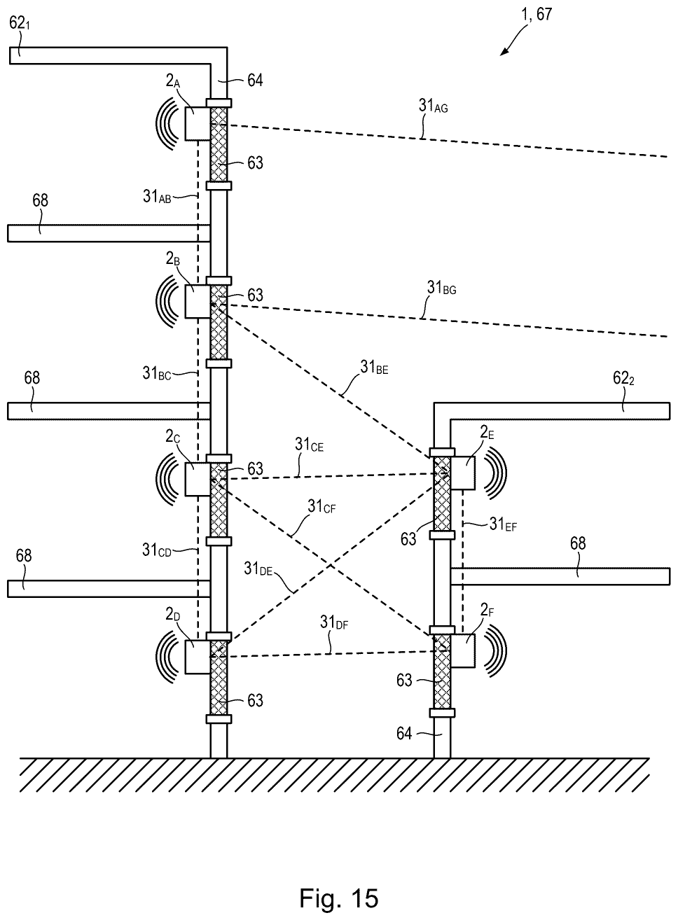

Referring also to FIG. 15, a third example system 1, 67 is shown.

The third example system 1, 67 is similar to the first example system 61, except that it is shown in greater detail for the purposes of illustrating applications of the system 1, 67.

Radios 2_{A}, . . . , 2_{F} are supported on windows 63 of the first 62₁ and second buildings 62₂. Each radio 2 includes an electronically steerable transceiver 4, 5 directed outwards from the corresponding window 63, and another transceiver 4, 5, either wide angle or switchable between first and second modes, directed into the building 62₁, 62₂ interior. The transceivers 4, 5 of the radios 2_{A}, . . . , 2_{F} are oriented to also enable forming links 31 through the internal floors 68 (typically thinner than a roof or external walls) of the buildings 62₁, 62₂. Although not shown in FIG. 15, further radios 2 are preferably included within either or both buildings 62₁, 62₂, so as to extend the system 1 and relaying of radio signals 3 to areas of the buildings 62₁, 62₂ which are not close to any windows 63 (for example to relay around LOS blocking objects 33 such as internal walls and so forth).

The radios 2_{A}, 2_{B} mounted to the highest windows have LOS links 31_{AG}, 31_{BG} to a gateway 29 in the form of a mobile phone base station, and form a network with the other radios 2_{C}, . . . , 2_{F} to relay radio signals 3 inside and between the buildings 62₁, 62₂, to allow user devices 28 located within the buildings 62₁, 62₂ to be able to communicate back to the gateway 29 without direct LOS.

### Modifications

It will be appreciated that many modifications may be made to the embodiments hereinbefore described. Such modifications may involve equivalent and other features which are already known in the design, manufacture and use of wireless transceivers, radios and/or networks thereof, and which may be used instead of or in addition to features already described herein. Features of one embodiment may be replaced or supplemented by features of another embodiment. For example, features of one wireless transceiver, radio and/or network thereof may be replaced or supplemented by features of other wireless transceivers, radios and/or networks thereof.

It has been described that the radios 2 need not, and generally are not, configured to extract and process packets from radio signals 3. However, in some examples, one, some or even all of the radios 2 may be configured to extract and process packets from radio signals 3 in addition to the described relaying functions.

When a second transceiver 5 is configured to be operable in first and second modes, each time-multiplexed routing configuration 30 will define whether that second transceiver 2 should be operated in the first (direction) mode or the second (wide angle) mode.

For convenience, relaying of radio signals 3 has been described from a first transceiver 4 of a source radio 2 to a second transceiver 5 of a target radio 2. However, when radios 5 are configured for bi-directional communications, radio signals 3 may be relayed as described herein in any one of the following combinations:
From a first transceiver 4 of a source radio 2 to a second transceiver 5 of a target radio 2;
from a second transceiver 5 of a source radio 2 to a first transceiver 4 of a target radio 2;
from a first transceiver 4 of a source radio 2 to a first transceiver 4 of a target radio 2; and/or
from a second transceiver 5 of a source radio 2 to a second transceiver 5 of a target radio 2.

At the start of a scheduled or requested re-mapping, each radio 2 may, prior to scanning, point its first transceiver 4 in turn at each other radio 2 stored in its current routing table to verify the existing LOS links 31. Subsequently, the angles φ₁ more than the first beams width w_{b} from existing LOS links 31 may be scanned as described hereinbefore to look for new LOS links 31.

Although claims have been formulated in this application to particular combinations of features, it should be understood that the scope of the disclosure of the present disclosure also includes any novel features or any novel combination of features disclosed herein either explicitly or implicitly or any generalization thereof, whether or not it relates to the same disclosure as presently claimed in any claim and whether or not it mitigates any or all of the same technical problems as does the present disclosure. The applicant hereby gives notice that new claims may be formulated to such features and/or combinations of such features during the prosecution of the present application or of any further application derived therefrom.

1. A radio for networked relaying of radio signals within a first frequency band, the radio comprising:
a first transceiver for the first frequency band, the first transceiver being electronically steerable to a first direction;
a second transceiver for the first frequency band, wherein the radio is configured to relay a radio signal received by the second transceiver to the first transceiver via an analog signal path and to retransmit the radio signal using the first transceiver; and
a control transceiver for communicating with a wireless network comprising a plurality of other radios using a second frequency band lower than the first frequency band, each of the plurality of other radios comprising same elements as the radio, wherein the radio is configured to coordinate with the plurality of other radios via the wireless network to:
control the first transceiver and the second transceiver to determine a network map for relaying the radio signals within the first frequency band; and
determine one or more time-multiplexed routing configurations of the radio, wherein the radio is configured, during a time period corresponding to at least one time-multiplexed routing configuration, to steer the first transceiver to a respective first configuration direction corresponding to one of the plurality of other radios.

2. The radio of claim 1, wherein coordinating with the plurality of other radios via the wireless network to determine the network map comprises:
controlling the first transceiver to transmit a test signal whilst scanning the first direction through a range of available angles;
listening, via the wireless network, for one or more LOS confirmation messages transmitted by other radios, each LOS confirmation message comprising a reception time and an identifier of a corresponding other radio; and
in response to receiving a LOS confirmation message from one of the plurality of other radios, determining the first direction corresponding to the respective reception time and adding that other radio to a routing table stored by the radio.

3. The radio of claim 1, wherein coordinating with the plurality of other radios via the wireless network to determine the network map comprises:
listening, using the second transceiver, for one or more test signals transmitted by other radios; and
in response to receiving a test signal from one of the plurality of other radios, transmitting a LOS confirmation message to that other radio via the wireless network, the LOS confirmation message comprising:
an identifier of the radio; and
a reception time corresponding to a maximum power of the test signal.

4. The radio of claim 1, wherein determination of the one or more time-multiplexed routing configurations of the radio is based on a dynamic routing method.

5. The radio of claim 1, wherein the radio is configured to coordinate with the plurality of other radios via the wireless network to control the first transceiver and the second transceiver to determine the network map according to a schedule.

6. The radio of claim 1, wherein the radio is configured to coordinate with the plurality of other radios via the wireless network to control the first transceiver and the second transceiver to determine the network map in response to receiving a mapping request message.

7. The radio of claim 1, wherein the radio is configured, in response to relaying the radio signal using the first transceiver and the second transceiver, to:
transmit, via the wireless network, a first relay confirmation message to a source radio of the plurality of other radios corresponding to an active time-multiplexed routing configuration;
listen for a predetermined period, via the wireless network, for a second relay confirmation message from a target radio of the plurality of other radios corresponding to the active time-multiplexed routing configuration;
in response to the predetermined period elapsing without reception of the second relay confirmation message, increment a failure counter corresponding to the target radio; and
in response to the failure counter exceeds a broken-link threshold, transmit a mapping request message via the wireless network.

8. The radio of claim 1, wherein the second transceiver is electronically steerable to a second direction.

9. The radio of claim 8, when dependent from claim 3, wherein listening, using the second transceiver, for one or more test signals transmitted by other radios comprises scanning the second direction through a range of available angles.

10. The radio of claim 8, wherein the second transceiver is configured to be operable in:
a first mode corresponding to a radiation pattern comprising a beam which is electronically steerable to the second direction; and
a second mode corresponding to reception of signals from a broader angular distribution than the beam of the first mode.

11. The radio of claim 10, wherein the first mode and the second mode correspond to switching between different antennae or arrays of antennae.

12. The radio of claim 10, wherein the first mode and the second mode correspond to same antennae or arrays of antennae.

13. The radio of claim 8, wherein the radio is configured, during a corresponding time period corresponding to at least one corresponding time-multiplexed routing configuration, to steer the second transceiver to a respective second configuration direction corresponding to one of the plurality of other radios.

14. The radio of claim 1, further comprising;
a third transceiver for the first frequency band, the third transceiver being electronically steerable to a third direction; and
a fourth transceiver configured same as the second transceiver, wherein:
the radio is configured to relay a corresponding radio signal received by the fourth transceiver to the third transceiver via a second analog signal path, and to retransmit the radio signal using the third transceiver; and
the radio is configured, during a corresponding time period corresponding to at least one corresponding time-multiplexed routing configuration, to steer the third transceiver to a respective third configuration direction corresponding to one of the plurality of other radios, so as to relay radio signals in the opposite direction to the first transceiver and the second transceiver.

15. The radio of claim 1, wherein the radio is configured to:
relay the radio signal received by the second transceiver to the first transceiver via the analog signal path and to retransmit the radio signal using the first transceiver during time periods corresponding one or more first time-multiplexed routing configurations; and
relay a corresponding radio signal received by the first transceiver to the second transceiver via a corresponding analog signal path and to retransmit the radio signal using the second transceiver during time periods corresponding one or more second time multiplexed routing configurations.

16. The radio of claim 3, wherein the radio further comprises a receiver channel coupled to the analog signal path and configured to detect the test signals.

17. The radio of claim 2, wherein the radio further comprises a test transmission channel coupled to the analog signal path and configured to inject the test signal for transmission by the first transceiver.

18. A system comprising:
a plurality of radios, wherein;
each of the plurality of radios being a radio for networked relaying of radio signals within a first frequency band, the radio comprising:
a first transceiver for the first frequency band, the first transceiver being electronically steerable to a first direction;
a second transceiver for the first frequency band, wherein the radio is configured to relay a radio signal received by the second transceiver to the first transceiver via an analog signal path and to retransmit the radio signal using the first transceiver; and
a control transceiver for communicating with a wireless network comprising a plurality of other radios using a second frequency band lower than the first frequency band, each of the plurality of other radios comprising same elements as the radio;
the wireless network is formed between the plurality of radios, and wherein each radio of the plurality of radios is configured to coordinate with other radios of the plurality of radios via the wireless network to:
control the first transceiver and the second transceiver to determine a network map of the system for relaying the radio signals within the first frequency band; and
determine one or more time-multiplexed routing configurations for each of the radios, wherein the radio is configured, during a time period corresponding to at least one time-multiplexed routing configuration, to steer the first transceiver to a respective first configuration direction corresponding to one of the plurality of other radios.

19. The system of claim 18, wherein to coordinate with the other radios of the plurality of radios via the wireless network to determine the network map, each corresponding radio of the plurality of radios is to:
control the first transceiver of the corresponding radio to transmit a test signal while scanning the first direction through a range of available angles;
listen, via the wireless network, for one or more LOS confirmation messages transmitted by the other radios, each LOS confirmation message comprising a reception time and an identifier of a corresponding other radio; and
in response to receiving a LOS confirmation message from one of the other radios, determine the first direction corresponding to the respective reception time and adding the one of the other radios to a routing table stored by at least one of the one of the corresponding radio or elsewhere within the system.

20. The system of claim 18, wherein to coordinate with the other radios of the plurality of radios via the wireless network to determine the network map, each corresponding radio of the plurality of radios is to:
listen, using the second transceiver of the corresponding radio, for one or more test signals transmitted by the other radios; and
in response to receiving a test signal from one of the other radios, transmit a LOS confirmation message to the one of the other radios via the wireless network, the LOS confirmation message comprising:
an identifier of the corresponding radio; and
a reception time corresponding to a maximum power of the test signal.

21. The system of claim 18, wherein processing to determine the network map and the one or more time-multiplexed routing configurations for each of the radios is carried out by a subset of one or more of the plurality of radios.

22. The system of claim 18, wherein processing to determine the network map and the one or more time-multiplexed routing configurations for each of the radios is distributed across two of more of the plurality of radios.

23. The system of claim 18, further comprising a gateway and one or more user devices, wherein the one or more time-multiplexed routing configurations for each of the radios are determined such that each user device of the one or more user devices has a connection to the gateway via the plurality of radios during at least one time period.

24. The system of claim 18, wherein the plurality of radios comprises one or more of:
one or more radios supported by a structure, wherein each radio of the one or more radios supported by the structure is supported on an exterior of the structure or supported internally within the structure;
one or more radios supported by a vehicle; or
one or more user devices.

25. A method for networked relaying of radio signals within a first frequency band using a radio, the method comprising:
coordinating the radio with a plurality of other radios to determine a network map for the relaying of the radio signals within the first frequency band, the radio comprising:
a first transceiver for the first frequency band, the first transceiver being electronically steerable to a first direction;
a second transceiver for the first frequency band; and
a control transceiver for communicating with a wireless network comprising the plurality of other radios using a second frequency band lower than the first frequency band, each of the plurality of other radios comprising same elements as the radio;
determining one or more time-multiplexed routing configurations of the radio; and
during each of one of more time periods corresponding to time-multiplexed routing configurations:
steering the first transceiver of the radio to a respective first configuration direction corresponding to one of the other radios; and
in response to receiving a radio signal in the first frequency band using the second transceiver, relaying that radio signal via an analog signal path and retransmitting that radio signal using the first transceiver.
